(19) United States
(12) Patent Application Publication
(10) Pub. No.: US 2015/0068627 A1
(43) Pub. Date: Mar. 12, 2015

(54) DIRECTION OF MOTION CONVERSION MECHANISM, ACTUATOR DEVICE USING THE SAME, AND REAGENT MANUFACTURING APPARATUS

(71) Applicant: Hitachi, Ltd., Tokyo (JP)

(72) Inventors: Kunio HARADA, Tokyo (JP); Akihiro FURUKAWA, Tokyo (JP); Masakazu SUGAYA, Tokyo (JP); Norihito KUNO, Tokyo (JP); Hisashi MURATA, Tokyo (JP)

(73) Assignee: Hitachi, Ltd.

(21) Appl. No.: 14/478,453

(22) Filed: Sep. 5, 2014

(30) Foreign Application Priority Data
Sep. 9, 2013 (JP) 2013-186757

(51) Int. Cl. F16K 11/085; F16H 25/12

(52) U.S. Cl. CPC F16K 11/0853; F16H 25/12
USPC 137/625.47; 74/57

(57) ABSTRACT

An actuator device includes a pin that performs translatory motion along a groove of a cam to which a three-way stopcock is connected, the cam that performs rotary motion, and a control unit that causes the pin to perform the translatory motion along an extending direction of the cam, and rotates the cam with respect to a central axis of rotation, thereby to divert a passage of the three-way stopcock. A first, second, third, and fourth grooves that form the groove have a linked shape. Directions of inclinations of the first inclination angle and the third inclination angle are opposite with respect to the central axis, and directions of inclinations of the second inclination angle and the fourth inclination angle are opposite with respect to the central axis.

### CROSS-REFERENCE TO RELATED APPLICATIONS

This application claims the priority of Japanese Patent Application No. 2013-186757, filed on Sep. 9, 2013, which is incorporated herein by reference in its entirety.

### BACKGROUND OF THE INVENTION

1. Field of the Invention

The present invention relates to a direction of motion conversion mechanism, an actuator device, and a reagent manufacturing apparatus, and especially relates to a direction of motion conversion mechanism, an actuator device, and a reagent manufacturing apparatus that rotate a cock of a stopcock that diverts a passage of a liquid.

2. Description of the Related Art

In the medical field, three-way stopcocks are often used for diverting a passage of a reagent solution.

The three-way stopcock is a part that selects a connection port among three connection ports by rotating an external cock connected to a valve in which passages are partitioned in a T-shaped manner and partitions passages among three connection ports inside the passages at positions 90 degrees away from each other in a T-shaped manner. Positions where the cock is rotated and stopped are 0 degrees, 90 degrees, 180 degrees, and 270 degrees, and it is necessary to stop at any of four positions at every 90 degrees. Further, regarding a direction into which the cock is rotated, there are cases where a rotation angle goes and returns within 270 degrees, and where the direction is restricted to one of right rotation and left rotation.

The three-way stopcocks are supposed to be used in a disposable manner for prevention of infectious diseases, and are available in a sterilized state at a reasonably low cost. Therefore, the three-way stopcocks are used inside the passages for synthesis or dispensation of reagents in reagent manufacturing systems for positron emission tomography (PET) in a disposable manner with limited usage.

When a three-way stopcock is used, typically, in the medical field, a cock is rotated by hand to divert the passage. However, in the PET reagent manufacturing system, a reagent that emits high-intensity radiation is used, and thus an actuator device that rotates the cock performs the function, instead of a manual operation. However, the actuator device has a concern, such as deterioration of an insulation material due to radiation, and malfunction of a semiconductor, and thus it is necessary to use an actuator device using air pressure rather than electric motors.

As a drive source of the actuator device using air pressure, a translatory-type pneumatic cylinder or an oscillation-type pneumatic rotary actuator device is typically used. When a pneumatic rotary actuator device is used as the drive source, the cock of the three-way stopcock is connected to an output shaft of the pneumatic rotary actuator device so that the output shaft can be rotated. However, when a translatory-type pneumatic cylinder is used as the drive source, it is necessary to convert translatory motion into rotary motion in some sort of system to rotate the cock of the three-way stopcock.

In either case, the drive source performs reciprocating movement with full stroke. Therefore, there is a problem that it is necessary to employ a method of adding a mechanism to stop the movement in the middle of the stroke, or to employ a combination of a plurality of drive sources in order to handle the four positions of the direction of cock rotation.

Note that, as a first example of a valve opening/closing device using a translatory-type pneumatic cylinder as the drive source, there is JP-2010-84847-A. In JP-2010-84847-A, a cam is used to convert the translatory motion into the rotary motion. In JP-2010-84847-A, the cam having a groove processed in a flat plate performs reciprocating translatory movement, and thus the converted rotary motion performs a reciprocating rotary motion, and a seat of a valve attached to the axis of rotation performs a reciprocating open/close operation by the reciprocating translatory movement. JP-2010-84847-A has problems that only the reciprocating rotary motion is realized as described above, and the device cannot be stopped at an arbitrary angle in every 90 degrees.

As a second example, there is JP-3331553-B as the actuator device that converts the translatory motion into the rotary motion using a translatory-type pneumatic cylinder as the drive source. Even in JP-3331553-B, a cam is used to convert the translatory motion in to the rotary motion. In JP-3331553-B, a spline that serves as an output shaft is rotated by a reciprocating translatory motion along the connected spline by a lead groove (corresponding to a cam) side formed in a piston, and rotation using an engaged ball (corresponding to a cam follower) as a reference. That is, the cam performs both of the reciprocating motion and the rotary motion to convert the translatory motion into the rotary motion. Therefore, there is a problem of structural difficulty in assembly. Further, in JP-3331553-B, a linear portion has a deep groove, and the groove is gradually shallower from a bending portion of the lead groove to the other end side. Thus, there is problem that it is necessary to process the lead groove to gradually change the depth, and the processing is difficult.

When considering the mechanism that converts the translatory motion into the rotary motion as the actuator device that rotates a cock of a three-way stopcock other than the above two known technologies, use of an input and an output of the mechanism that converts the rotary motion into the translatory motion in a reverse manner can be considered. As the mechanism that converts the rotary motion into the translatory motion, there is JP-2010-151206-A.

JP-2010-151206-A has a structure in which a cylindrical cam is continuously rotated, so that a contact (corresponds to a cam follower) continuously performs reciprocating movement in an axial direction of the cylindrical cam. Conversion of the translatory motion into the rotary motion can be considered by using of the structure in a reverse manner. If the contact of JP-2010-151206-A is moved in the axial direction of the cylindrical cam using a translatory-type pneumatic cylinder, or the like, the cylindrical cam is rotated. However, when the translatory motion is converted into the rotary motion with the structure of JP-2010-151206-A, the contact is moved into one direction, and the contact reaches the peak at a bending portion of the cam groove. Then, when the contact is tried to move into an opposite direction, whether the contact is moved into a first linear portion of the cam groove or into a second linear portion cannot be accurately selected.

If the reciprocating motion is continuously performed, the reciprocating motion may be able to be converted into continuous rotation by inertia force of the cylindrical cam. However, the purpose is not the continuous rotation of the cock of the three-way stopcock but stop of the cock at an arbitrary position. Therefore, if the direction into which the contact is moved cannot be selected, the purpose cannot be achieved by use of the structure of JP-2010-151206-A in a reverse manner. Note that, in JP-2010-151206-A, angles of the first linear portion and the second linear portion of the groove cam seem different. As a result, when the contact is moved into an opposite direction after the contact reaches the peak, whether the contact is moved into the first linear portion or to the second linear portion of the cam groove may be able to be selected.

However, there is a problem that malfunction occurs if a substantial difference is not given to a difference in the angles of the first linear portion and the second linear portion of the cam groove. The malfunction occurs due to frictional force between the cam groove and the contact, or a movement error occurring from a gap due to dimensional tolerance of parts.

### SUMMARY OF THE INVENTION

In the medical field, especially in a system of manufacturing a PET reagent, the cock needs to be rotated and stopped at an arbitrary position of the four positions at every 90 degrees, regarding the actuator device used for rotating the cock of the three-way stopcock to divert passages of the reagent solution. There are following problems to satisfy the condition that the actuator device can handle both of the case where a rotation angle goes and returns within 270 degrees and the case where the direction is restricted to one of right rotation and left rotation, and furthermore, the actuator device needs to use a drive force by air pressure having a less adverse effect of radiation.

Typically, to handle the four positions of the direction of cock rotation by the drive force by air pressure that performs reciprocating motion with full stroke, there is a problem that measures using a method of adding a mechanism to stop the movement in the middle of the stroke, or a combination of a plurality of drive sources are necessary. Further, when the reciprocating motion of a cam with a groove processed in a flat plate is converted into the rotary motion, there are problems that the reciprocating motion needs to be converted into not only the reciprocating rotation but also an arbitrary rotation direction into which the cock can be rotated, and the movement needs to be stopped in the middle of the stroke at an arbitrary angle.

Further, in a case of a mechanism using a gear, even if rotational force other than the drive force is applied, idle running needs to be avoided. In a case of a mechanism in which the cam performs both of the reciprocating motion and the rotary motion, the actuator device needs to be easily assembled. In a case where the lead groove needs to be processed such that the depth is gradually changed, the structure needs to be easily processed. Further, in a case where the mechanism that converts the rotary motion into the translatory motion is used in a reverse manner, a direction of rotation needs to be accurately selected without having malfunction.

An objective of the present invention is to provide a technology to enable selection of a direction of cam rotation in diversion of a passage using a stopcock, and enables easy processing/assembly of an actuator device.

The above and other objectives and new characteristics of the present invention will be made clear from description of the present specification and appended drawings.

An outline of a representative invention from among the inventions disclosed in the present application will be described as follows.

A direction of motion conversion mechanism according to the present invention includes a translatory mechanism unit including a cam follower that moves along a groove in a cylindrical surface of a cam, and performs translatory motion, and a rotation mechanism unit in which the cam performs rotary motion. Further, the groove of the direction of motion conversion mechanism includes a first groove having a first inclination angle, a second groove having a second inclination angle, a third groove having a third inclination angle, and a fourth groove having a fourth inclination angle, and the first, second, third, and fourth grooves have a linked shape. Further, in the direction of motion conversion mechanism, direction of inclinations of the first groove and the third groove are opposite with respect to a central axis of rotation, and directions of inclinations of the second groove and the fourth groove are opposite with respect to the central axis of rotation.

An actuator device according to the present invention includes a translatory mechanism unit including a pin that moves along a groove in a cylindrical surface of a cam to which a three-way stopcock is connected, a rotation mechanism unit in which the cam performs rotary motion, and a pin drive unit that causes the pin to perform translatory motion along an extending direction of the cam. Further, the groove of the cam of the actuator device includes a first groove having a first inclination angle, a second groove having a second inclination angle, a third groove having a third inclination angle, and a fourth groove having a fourth inclination angle, and the first, second, third, and fourth grooves have a linked shape. In the groove of the cam of the actuator device, directions of inclinations of the first groove and the third groove are opposite with respect to a central axis of rotation, and directions of inclinations of the second groove and the fourth groove are opposite with respect to the central axis of rotation.

A reagent manufacturing apparatus according to the present invention includes an actuator device including a translatory mechanism unit including a pin that moves along a groove in a cylindrical surface of a cam to which the three-way stopcock is connected, and performs translatory motion. Further, the reagent manufacturing apparatus includes a rotation mechanism unit in which the cam performs rotary motion, piping to which a plurality of the three-way stopcocks is connected, and a control unit that diverts passages of the three-way stopcocks by causing the pin to perform the translatory motion along an extending direction of the cam, and to rotate the cam. Further, in the reagent manufacturing apparatus, the groove includes a first groove having a first inclination angle, a second groove having a second inclination angle, a third groove having a third inclination angle, and a fourth groove having a fourth inclination angle, and the first, second, third, and fourth grooves have a linked shape. Further, in the reagent manufacturing apparatus, directions of inclinations of the first groove and the third groove are opposite with respect to a central axis of rotation, and directions of inclinations of the second groove and the fourth groove are opposite with respect to the central axis of rotation, and the control unit controls timing to divert the passages of the three-way stopcocks.

Effects obtained from the representative invention from among the inventions disclosed in the present application will be briefly described as follows.

Selection of a direction of cam rotation in diversion of a passage using a stopcock is possible, and rotation/stop of the cam by every 90 degrees can be reliably performed. In addition, processing/assembly of an actuator device can be easily performed.

### BRIEF DESCRIPTION OF THE DRAWINGS

FIG. 1 is a partial configuration diagram illustrating an example of a piping system in reagent manufacturing system of a first embodiment of the present invention;

FIGS. 2A, 2B, and 2C are partial configuration diagrams illustrating a part of the reagent manufacturing system illustrated in FIG. 1, where the part is enlarged;

FIG. 3 is a side view illustrating a configuration of a three-way stopcock diversion actuator device of a first embodiment of the present invention, where a part of the configuration is broken;

FIGS. 4A, 4B, and 4C are cross sectional views illustrating a structure of the actuator device illustrated in FIG. 3, and FIG. 4A illustrates positions of limit (rotation position detection) switches, FIG. 4B illustrates positions of pins, and FIG. 4C illustrates positions of anti-rotation pins;

FIG. 5 is a side view illustrating a structure of a cam of the actuator device of FIG. 3, where a part of the structure is broken;

FIG. 6 is a developed diagram of an outer periphery of the cam illustrated in FIG. 5;

FIG. 7 is a configuration diagram for describing a principle of rotation of the cam illustrated in FIG. 5;

FIGS. 8A, 8B, and 8C are partial plan views illustrating examples of a connection portion of a second groove and a third groove illustrated in FIG. 7;

FIG. 9 is a side view illustrating a structure of a cam of a modification of the first embodiment of the present invention, where a part of the structure is broken;

FIG. 10 is a developed diagram of an outer periphery of the cam illustrated in FIG. 9;

FIG. 11 is a configuration diagram for describing a principle of rotation of the cam illustrated in FIG. 9;

FIG. 12 is a side view of a configuration of a three-way stopcock diversion actuator device of a second embodiment of the present invention;

FIG. 13 is a partial cross sectional view illustrating a configuration of a cylinder of the actuator device of FIG. 12;

FIG. 14 is a side view illustrating a structure of a cam of the actuator device of FIG. 13, where a part of the structure is broken;

FIG. 15 is a developed diagram of an outer periphery of the cam illustrated in FIG. 14;

FIG. 16 is a configuration diagram for describing a principle of rotation of the cam illustrated in FIG. 14;

FIG. 17 is a side view illustrating a structure of a cam of a modification of the second embodiment of the present invention, where a part of the structure is broken;

FIG. 18 is a developed diagram of an outer periphery of the cam illustrated in FIG. 17;

FIG. 19 is a configuration diagram for describing a principle of rotation of the cam illustrated in FIG. 17;

FIG. 20 is a configuration diagram illustrating an example of a connection state of a pneumatic cylinder, piping, control solenoid valves, and an air pressure source in the actuator device illustrated in FIG. 12;

FIG. 21 is a configuration diagram illustrating an example of a reagent manufacturing apparatus of a third embodiment of the present invention; and

FIG. 22 is an enlarged partial perspective view illustrating the A portion illustrated in FIG. 21, where a part of the A portion is broken.

### DESCRIPTION OF THE PREFERRED EMBODIMENTS

In the following embodiments, description of the same or similar portions is basically not repeated unless otherwise especially needed.

Further, if such description is needed in the following embodiments as a matter of convenience, the description will be given by being divided into a plurality of sections or embodiments. The sections or embodiments are not unrelated to each other, and there is a relationship that one is a modification, details, or supplementary explanation of a part or whole of the other unless otherwise especially indicated.

Further, in the following embodiments, when referring to the number of an element (including a numerical value, an amount, and a range), the number of an element is not limited to a specific number, and the number may be larger/smaller than the specific number unless otherwise especially indicated, or the number is apparently limited to the specific number in principle.

Further, in the following embodiments, a configuration element (including an element step) is not necessarily essential unless otherwise especially indicated, or the configuration element is apparently essential in principle.

Further, in the following embodiments, when referring to a configuration element or the like, it is apparent that the wording of “X made of A”, “X formed of A”, “X having A”, or “X including A” does not exclude elements other than A, except the case of especially stating that there is only the element. Similarly, in the following embodiments, when referring to a shape of a configuration element, or a positional relationship, or the like, matters substantially approximating or similar to the shape or the like are included, unless otherwise especially stated, or the matter seems clearly improper in principle. The same applies to the numerical values and ranges.

Hereinafter, embodiments of the present invention will be described in details with reference to the drawings. Note that members having the same function are denoted with the same reference signs in all of the drawings for describing the embodiments, and repetitive description is omitted. Further, hatching may be provided even to a plan view for making the drawing to easier understand.

### First Embodiment

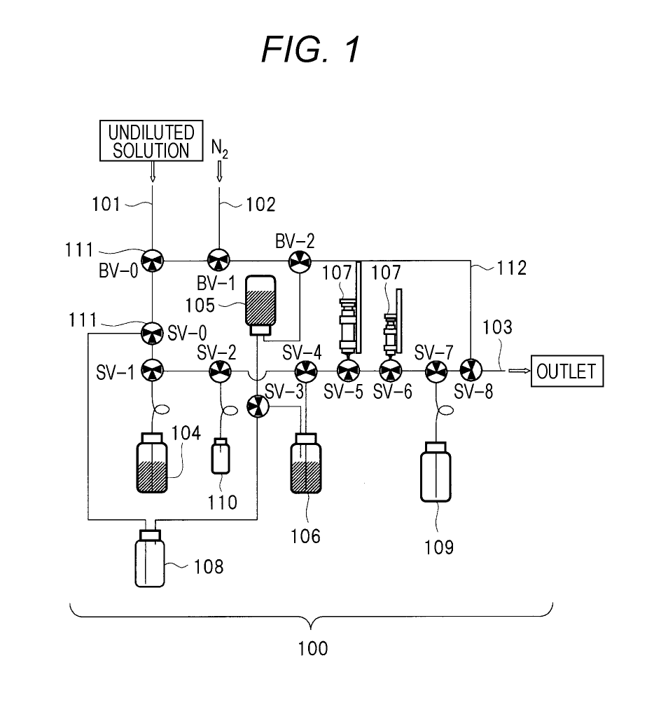

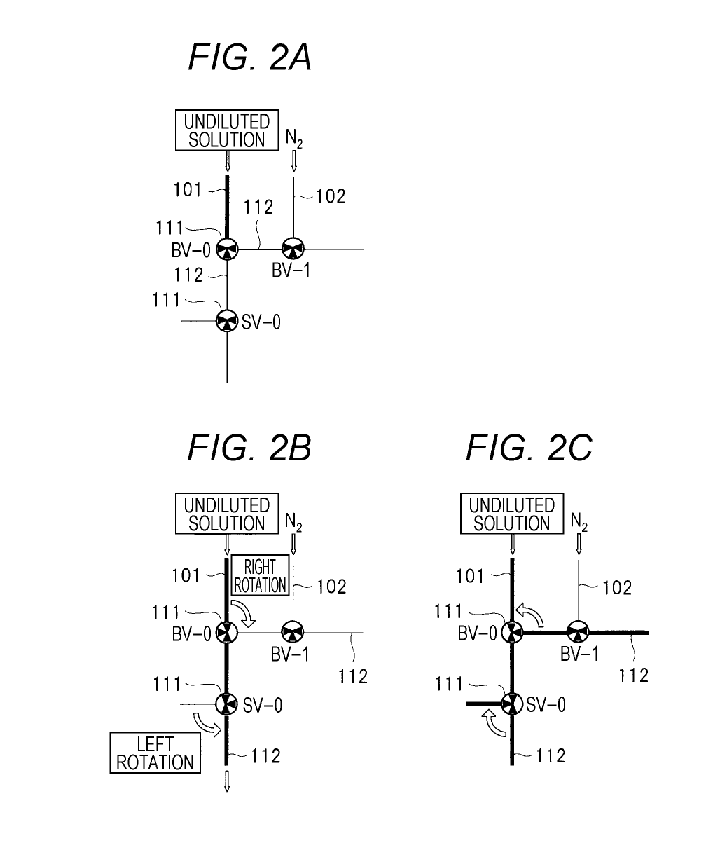

FIG. 1 is a partial configuration diagram illustrating an example of a piping system in a reagent manufacturing system of a first embodiment of the present invention, and FIGS. 2A, 2B, and 2C are partial configuration diagrams illustrating the reagent manufacturing system illustrated in FIG. 1, where a part of the system is enlarged.

First, an operation of a PET reagent manufacturing system will be described with reference to FIGS. 1, and 2A to 2C. In the reagent manufacturing system that synthesizes and dispenses a reagent, an undiluted solution of a reagent that emits high-intensity radiation is synthesized with a diluent, concentration tuning is performed, and mixed liquor is dispensed into individual containers. FIG. 1 illustrates a piping system 100 before a stage of dispensing the mixed liquor into individual containers. The piping system 100 includes an undiluted solution intake port 101 that takes in an undiluted solution, a nitrogen gas intake port 102 that takes in a purge nitrogen gas in the piping, and an outlet 103 for sending a reagent after the concentration tuning to individual dispensation piping that is a next process.

Further, the piping system 100 includes an undiluted solution collection container 104 for collecting the undiluted solution, a diluent container 105 that stores the diluent, and a diluent collection container 106 for collecting the diluent. Further, the piping system 100 includes two types of syringe pumps 107 that suck/discharge collected undiluted solution or diluent in the piping, a waste collection container 108, a synthesis container 109, and another waste collection container 110. These pumps and containers are connected by a plurality of lines of piping 112 through respective three-way stopcocks 111.

Each of the three-way stopcocks 111 is illustrated in the drawing such that three triangles face one another in a circle. The triangles are rotated in the circle. Each of the three-way stopcock 111 is illustrated to allow distribution only in a direction corresponding to the piping 112 inside the three-way stopcock 111. Note that a total of twelve three-way stopcocks 111 including BV-0 to BV-2, and SV-0 to SV-8 are illustrated in FIG. 1. A plurality of three-way stopcocks 111 is used in the individual dispensation piping that is the next process (not illustrated in FIG. 1). For downsizing of the system, it is necessary to downsize the actuator device that rotates the cocks of the three-way stopcocks 111, especially, to downsize the magnitude of the direction projected on the sheet of FIG. 1.

Most of parts illustrated in the piping system 100 of FIG. 1, and most of parts used for the individual dispensation piping system in the next process are supplied in a state of being sterilized for prevention of infectious diseases. Further, these parts are used disposable of one time or several times, and are attached to the PET reagent manufacturing system before the start of an operation. Although not illustrated, a plurality of filters for securing sterility is attached to a plurality of places in the piping, and bent filters are attached to all of the containers except the diluent container 105.

Next, an operation in a portion of the PET reagent manufacturing system illustrated in FIG. 1 will be described. Note that the three-way stopcocks 111 are rotated and diverted each time.

When an operation is started, the undiluted solution enters through the undiluted solution intake port 101 into the piping 112, the undiluted solution passes through BV-0, SV-0, and SV-1 of the three-way stopcocks 111, and is collected in the undiluted solution collection container 104. At this time, the weight of the undiluted solution collected in the undiluted solution collection container 104, and the intensity of radiation inside the container are measured by measuring devices (not illustrated).

Next, to purge the undiluted solution remained in the piping 112 in the process, a nitrogen gas is introduced through the nitrogen gas intake port 102 into the piping, passes through BV-1, BV-0, and SV-0, and is collected in the waste collection container 108.

While it has been described that the three-way stopcocks 111 are rotated and diverted each time, it is important to divert the cocks of the three-way stopcocks 111 in right rotation or in left rotation. Restriction is given to the direction of rotation at the time of diverting the three-way stopcocks 111 in subsequent several processes including at the time of collecting the undiluted solution, and thus description will be given taking this process as an example.

FIGS. 2A to 2C are diagrams in which only the portions of BV-0, BV-1, and SV-0 are extracted from FIG. 1. FIGS. 2A to 2C illustrate actual directions of the three-way stopcocks 111, and illustrate the piping 112 to which pressure is applied by a thick line.

In FIGS. 1 and 2A, the undiluted solution enters the undiluted solution intake port 101 with certain pressure. At the first cock position of BV-0 of the three-way stopcock 111 in FIG. 1, the undiluted solution does not enter the piping 112, and is dammed up by BV-0 of the three-way stopcock 111.

Next, BV-0 of the three-way stopcock 111 is rotated rightward by 90 degrees on the sheet, and SV-0 of the three-way stopcock 111 is rotated leftward by 90 degrees on the sheet. When the three-way stopcocks 111 are set like FIG. 2B, the undiluted solution enters the piping 112 through the undiluted solution intake port 101, passes through BV-0 and SV-0 of the three-way stopcocks 111, and is collected in the undiluted solution collection container 104, as described above.

At this time, when BV-0 of the three-way stopcock 111 is rotated leftward by 270 degrees on the sheet, and SV-0 of the three-way stopcock 111 is rotated rightward by 270 degrees on the sheet, as illustrated in FIG. 2B, the three-way stopcocks 111 pass through the directions as illustrated in FIG. 2C in the middle of the rotation. Then, the undiluted solution flows into the range illustrated by the thick lines of the piping 112, as illustrated in FIG. 2C, which causes a problem. To avoid the problem, it is necessary to pay attention to the directions of rotation of the three-way stopcocks 111, and it is of course necessary that the actuator device that drives the three-way stopcocks 111 can select an arbitrary direction of rotation.

The operation in the portion in the PET reagent manufacturing system illustrated in FIG. 1 will be continuously described. After the undiluted solution is connected in the undiluted solution collection container 104, or in parallel processing, the nitrogen gas is introduced through the nitrogen gas intake port 102 to the diluent container 105 through BV-1 and BV-2 of the three-way stopcocks 111. Then, with the pressure, the diluent in the diluent container 105 is transferred to the diluent collection container 106 through SV-3 of the three-way stopcock 111.

Next, the undiluted solution having a predetermined amount in the undiluted solution collection container 104 is sucked in the syringe pump 107 through SV-1, SV-2, SV-4, and SV-5 of the three-way stopcocks 111. Following that, the total amount of the undiluted solution sucked in the syringe pump 107 is discharged into the synthesis container 109 through SV-5, SV-6, and SV-7 of the three-way stopcocks 111. Then, after the undiluted solution having the predetermined amount is discharged and collected in the synthesis container 109, the nitrogen gas is introduced through the nitrogen gas intake port 102 into the piping, passes through BV-1, BV-2, SV-8, SV-7, SV-6, SV-5, SV-4, and SV-2, and flows into the waste collection container 110. Further, the undiluted solution remained in the piping 112 is purged, and collected in the waste collection container 110. At this time, the weight of the undiluted solution collected in the synthesis container 109, and the intensity of radiation of the undiluted solution in the container are measured by measuring devices (not illustrated).

Next, the diluent having a predetermined amount in the diluent collection container 106 is sucked in the syringe pump 107 through SV-4 and SV-5 of the three-way stopcocks 111. Following that, the diluent sucked in the syringe pump 107 and having a predetermined amount is discharged into the synthesis container 109 through SV-5, SV-6, and SV-7 of the three-way stopcocks 111, and mixed and synthesized with the undiluted solution collected in the synthesis container 109 in advance. At this time, the weight of the undiluted solution and the diluent mixed in the synthesis container 109, and the intensity of radiation of the undiluted solution inside the container are measured by the measuring devices, and the diluent in the syringe pump 107 is discharged into the synthesis container 109 until the weight and the intensity of radiation reach predetermined reference values.

Then, the weight and the intensity of radiation in the synthesis container 109 reach the predetermined reference values, the diluent remained in the syringe pump 107 is disposed to the waste collection container 110 through SV-5, SV-4, and SV-2 of the three-way stopcocks 111. Further, the nitrogen gas is introduced through the nitrogen gas intake port 102 into the piping, passes through BV-1, BV-2, SV-8, SV-7, SV-6, SV-5, SV-4, and SV-2, and flows into the waste collection container 110. Following that, a residual liquid remained in the piping 112 is purged and collected in the waste collection container 110, and the synthesis operation is terminated.

An outline of the synthesis operation in the portion illustrated in FIG. 1 has been described. A subsequent operation is moved onto the individual dispensation, which is the next process. However, description is omitted here.

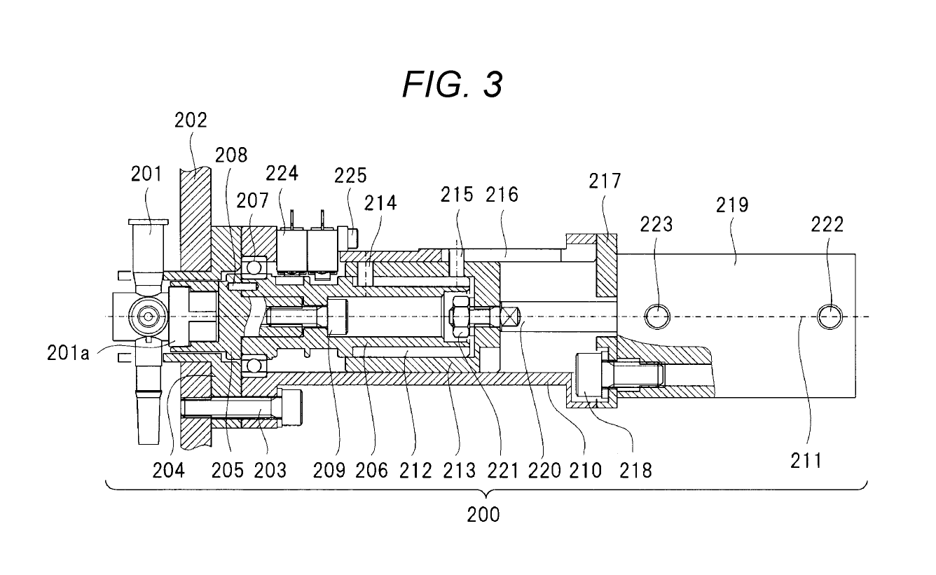

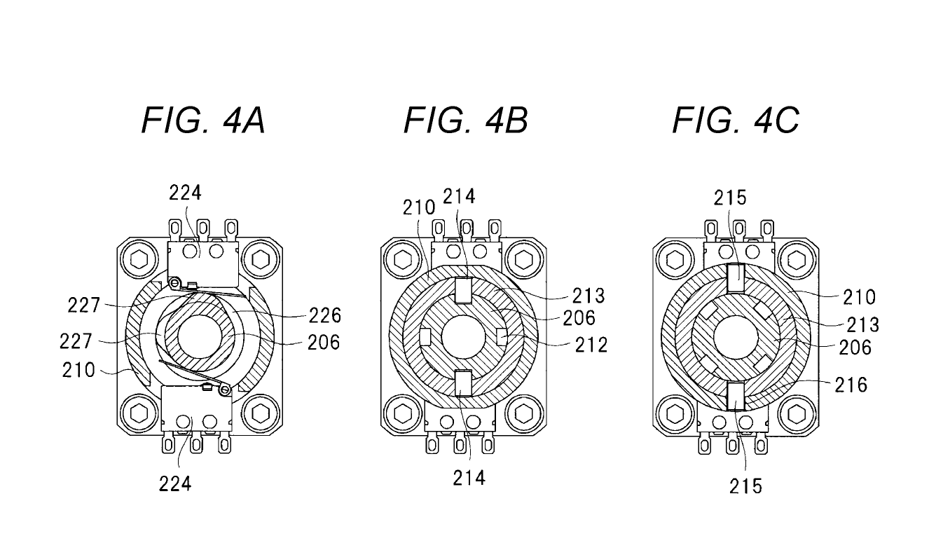

Next, a three-way stopcock diversion actuator device using a direction of motion conversion mechanism that converts the translatory motion into the rotary motion according to the present invention will be described with reference to FIGS. 3 to 11. FIG. 3 is a side view illustrating a configuration of a three-way stopcock diversion actuator device, illustrating a cross section obtained such that an upper half is cut in a vertical direction, and a lower half is cut in an oblique direction of about 45 degrees, based on the axis of rotation of the actuator device. FIGS. 4A, 4B, and 4C are cross sectional views obtained such that FIG. 3 is cut in a direction perpendicular to the axis of rotation and as viewed from a right direction of FIG. 3. Regarding the position of the cross section of each drawing, FIG. 4A illustrates positions of limit (rotation position detection) switches 224, FIG. 4B illustrates positions of pins 214, and FIG. 4C illustrates positions of anti-rotation pins 215.

A three-way stopcock diversion actuator device 200 illustrated in FIG. 3 is a portion except a three-way stopcock 201, an installation panel 202, and a fixing bolt 203. A main body of the three-way stopcock 201 is held in a holder 204, and a cock 201a is held by an output shaft 205. There are four cuts (not illustrated) in the held portion of the cock of the output shaft 205, and one of the four cuts has a different shape from others. Then, a position of a direction of rotation of the cock 201a with respect to the main body of the three-way stopcock 201 is uniquely determined by a position of a direction of rotation that can be confirmed by a rotation position detection mechanism described below.

The output shaft 205 interposes an inner race of a radial bearing 207 between the output shaft 205 and the cam 206, and a position of a direction of rotation is determined by a positioning pin 208. The output shaft 205 is fixed by a bolt 209. A housing 210 interposes an outer race of the radial bearing 207, and is fixed by the holder 204 and the fixing bolt 203. The output shaft 205 integrated with the cam 206 is rotatable inside the holder 204 and the housing 210 around a central axis 211 through the radial bearing 207.

Two pins 214 that are cam followers fixed to a slider 213 are meshed with a groove 212 of the cam 206 (see FIGS. 3 and 4B). The pins 214 have a columnar shape having a central axis perpendicular to (intersecting with) the central axis 211, and the diameter of the pins is slightly smaller than the groove 212. The slider 213 is capable of rotating around the central axis 211 and sliding in the axial direction of the central axis 211, along an inner diameter of the housing 210. However, movement of the anti-rotation pin 215 fixed to the slider 213 is restricted to movement along an anti-rotation groove 216 processed parallel to the central axis 211 in the housing 210. As a result, the slider 213 is not rotated, and is capable of performing only movement into the axis direction of the central axis 211 (see FIG. 4C).

Further, as illustrated in FIG. 3, a pneumatic cylinder (pin drive unit) 219 is fixed to a flange 217 by a bolt 218, and is fixed to a right side of the housing 210 by a bolt (not illustrated) through the flange 217.

Further, a tip screw portion of a piston rod 220 of the pneumatic cylinder 219 is screwed into the slider 213, and is fixed by an anti-loosening nut 221. As a result of this configuration, by supplying of air pressure is supplied to a port (intake and exhaust port) 222 at a pushing side of the pneumatic cylinder 219 and a port (intake and exhaust port) 223 at a pulling side, the slider 213 is moved in the axial direction of the central axis 211. Further, the pins 214 fixed to the slider 213 push a wall surface of the groove 212 formed in the cam 206, thereby to rotate the output shaft 205 to rotate the cock 201a of the three-way stopcock 201.

To smoothly perform this operation, a translatory axis of the translatory motion of the pins (translatory mechanism unit) 214 and the central axis 211 of the rotation of the cam (rotation mechanism unit) 206 are parallel or on the same straight line.

While details will be described below, the groove 212 formed in an outer periphery of the cylindrical surface of the cam 206 is constant in depth. Further, as illustrated in FIG. 4B, four sets of the grooves 212 are formed in a circumferential direction of the cam 206. One set of the groove 212 has a shape of rotating the cam 206 by 90 degrees in one reciprocating motion of the pneumatic cylinder 219. Note that, in the three-way stopcock diversion actuator device 200 of the present invention, the pulling side of the piston rod 220 of the pneumatic cylinder 219 (FIG. 3 is a state where the piston rod 220 is at the pushing side) is a reference position.

To detect the position of the cock 201a with respect to the main body of the three-way stopcock 201, as illustrated in FIGS. 3 and 4A, a limit switch 224 is attached to the housing 210 by a bolt 225. Two limit switches 224 each, as a total of four, as illustrated in FIG. 3, are attached to upper and lower point symmetrical positions, as illustrated in FIG. 4A. Two grooves 226 are formed in positions corresponding to the limit switches 224 illustrated in FIG. 3 in the outer periphery of the cam 206. Further, a protrusion 227 for pushing up levers of the limit switches 224 is formed in one position of each of the grooves 226.

The protrusions 227 formed in the grooves 226 have a phase difference by 90 degrees in the direction of rotation of the central axis 211, and the position of the direction of rotation corresponds to the groove 212 formed in the cam 206. Therefore, the four limit switches 224 correspond to 0 degrees, 90 degrees, 180 degrees, and 270 degrees, and when the piston rod 220 of the pneumatic cylinder 219 is at the pulling side, which is the reference position, only one of the four limit switches 224 is in an ON state. Accordingly, the position of the direction of rotation of the cock 201a with respect to the main body of the three-way stopcock 201 can be obtained.

In the three-way stopcock diversion actuator device 200 of the first embodiment, as illustrated in FIG. 3, and as described below, a part of the groove 212 formed in the cam 206 passes to a right end surface of the cam 206 in the drawing. Further, the anti-rotation groove 216 formed in the housing 210 also passes to a right end surface of the housing 210. Therefore, when the parts such as the cam 206 are assembled in the housing 210 from the right side of FIG. 3, by inserting of the pneumatic cylinder 219 to which the slider 213 is attached from the right side of FIG. 3, the three-way stopcock diversion actuator device 200 can be easily assembled.

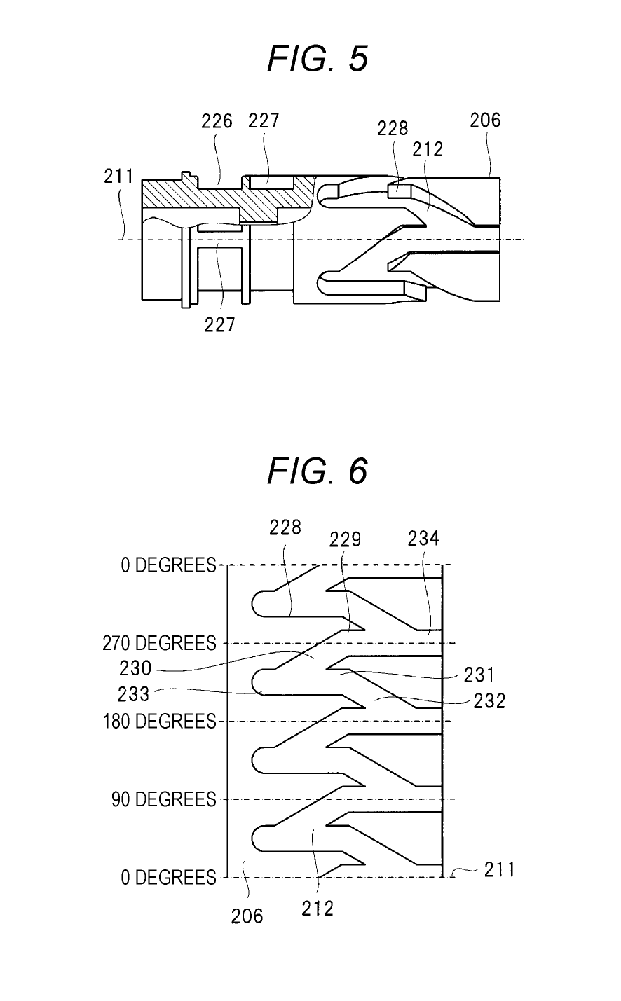

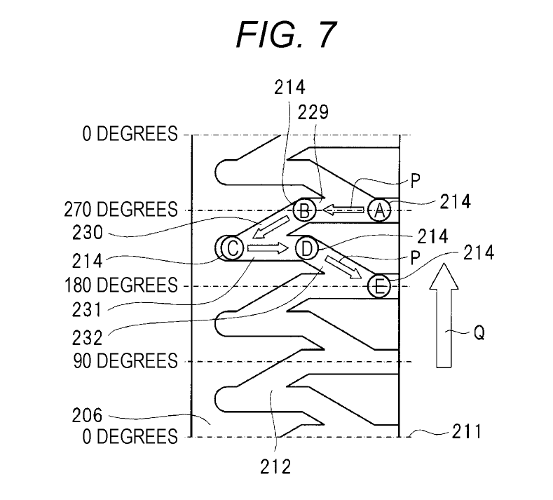

Next, the cam 206 of the first example and the groove 212 formed in the cam 206 in the first embodiment, and a principle of rotation of the cam 206 by the translatory motion of the pin 214 will be described. The side view of FIG. 5 illustrates a structure of the cam 206 of the first example, where only the cam 206 is taken out from FIG. 3. FIG. 6 illustrates the groove 212 of the cam 206 illustrated in FIG. 5 by developing the outer periphery of the cam 206. FIG. 7 illustrates a positional relationship between the groove 212 and the pin 214.

As illustrated in FIG. 5, the groove 212 is formed in the entire right-side outer periphery of the cam 206.

While, in FIG. 5, a wall surface 228 of the groove 212 can be seen, FIG. 6 is a developed diagram and thus the wall surface 228 is illustrated by a line. Therefore, all of portions (the walls of the groove) illustrated by the solid lines in FIG. 6 can be said to be the wall surfaces 228. FIG. 6 illustrates the central axis 211 illustrated in FIG. 5 by every 90 degrees.

In FIG. 6, in the groove 212, a groove line made of a first groove 229 illustrated in the position of 270 degrees in the drawing as a starting point, a second groove 230, a third groove 231, and a fourth groove 232 is formed in four places in a peripheral direction with a 90-degree pitch, and the four groove lines go around the outer periphery of the cam 206 once and are connected. That is, the first groove 229, the second groove 230, the third groove 231, and the fourth groove 232 are linked (in a loop manner), and four sets of the grooves 212 made of the first groove 229, the second groove 230, the third groove 231, and the fourth groove 232 are provided in the circumferential direction of the cylindrical surface of the cam 206. Further, the four sets of the grooves 212 are linked in the circumferential direction.

Note that a relief portion 233 of the pins 214 slightly extending from the connection portion of the third groove 231 and the second groove 230 to the left side in the axial direction of the central axis 211 is formed in the third groove 231.

Further, a cutout regio 234 extending from the connection portion of the first groove 229 and the fourth groove 232 to the right side in the axial direction of the central axis 211, and reaching a right-side termination of the cam 206 is formed in the first groove 229. The relief portion 233 and the cutout regio 234 perform a function to absorb an extra value even if the stroke of the pneumatic cylinder 219 exceeds a predetermined value. Therefore, an effect of performing formation with low stroke accuracy can be obtained if the stroke of the pneumatic cylinder 219 is formed slightly long.

Further, smaller inclination angles of the groove 212 with respect to the central axis 211, of the first groove 229 and the third groove 231, and the second groove 230 and the fourth groove 232, are 0 degrees (parallel). Further, the cutout regio (one end) 234 extending in the axial direction of the central axis 211 beyond a connection position of the groove 212 of the smaller inclination angles and an inclined portion of the groove 212 of larger inclination angles extends (is formed) to reach an end portion of the cylinder (cam 206).

Accordingly, the pneumatic cylinder 219 to which the slider 213 is attached can be inserted from the end portion side (the right side of FIG. 3) of the cam 206, and the three-way stopcock diversion actuator device 200 can be easily assembled.

Next, a principle of rotation of the cam 206 in the first embodiment by the translatory motion of the pin 214 will be described with reference to FIG. 7. In the first embodiment, actually, the cam 206 performs only rotation, and the pin 214 perform only translatory reciprocating motion in the axial direction of the central axis 211. However, in FIG. 7, the cam 206 is fixed, and the translatory reciprocating motion along the axial direction of the central axis 211 of the pin 214, and movement in the up and down direction on the sheet corresponding to the direction of rotation of the cam 206 are combined, and movement on a two-dimensional plane is described.

Further, in FIG. 7, movement of only one of the pins 214 is illustrated and the other is omitted because the drawing becomes complicated. However, as illustrated in FIG. 4B, the two pins 214 are used in the first embodiment, and the other pin 214 exists at a 180-degree opposite side to the position illustrated in FIG. 7 in the direction of rotation. Similarly, for reference, two anti-rotation pins 215 are used as illustrated in FIG. 4C.

In FIG. 7, the pin 214 performs reciprocating movement by the pneumatic cylinder 219 from a position illustrated by A, which is a reference position and is also a start position (start reference position) of this description, toward the left side in the axial direction of the central axis 211, as illustrated in FIG. 3. Accordingly, as illustrated in FIG. 7, the pin 214 proceeds in the first groove 229, the second groove 230, the third groove 231, and the fourth groove 232 in the direction illustrated by the small arrows P through positions illustrated by B, C, and D, and reaches a position E. When the pin 214 is moved from the position A to the position E, that is, from the position of 270 degrees to the position of 180 degrees illustrated in FIG. 7, the cam 206 is actually rotated by 90 degrees that is a difference from the position of 270 degrees to the position of 180 degrees in the direction of the large arrow Q of FIG. 7.

In other words, the pin 214 that is a translatory mechanism unit performs one-round translatory motion, starting from the connection position of the fourth groove 232 and the first groove 229 as the start reference position, toward one of the axial direction using the central axis 211 as a reference, to reach the connection position of the second groove 230 and the third groove 231, whereby the cam 206 that is the rotation mechanism unit performs the rotary motion of ¼ times (90 degrees). This direction of rotation is right rotation when FIG. 3 is viewed from the right side, and the three-way stopcock diversion actuator device 200 at that time is a right-rotation actuator device.

In the first embodiment, regarding a direction of inclination of each groove with respect to the central axis 211, the directions of inclinations of the second groove 230 and the fourth groove 232 are opposite, and the inclination angles are 30 degrees with respect to the central axis 211. Further, the first groove 229 and the third groove 231 are parallel to the central axis 211 (the inclination angle is 0 degrees). Note that, regarding the direction of inclination of each groove with respect to the central axis 211, the directions of inclinations of the first groove 229 and the third groove 231 are made opposite and the inclination angles are 30 degrees, and the second groove 230 and the fourth groove 232 are made parallel to the central axis 211 (the inclination angle is 0 degrees). In this case, the three-way stopcock diversion actuator device 200 is a left-rotation actuator device.

In other words, each of the first, second, third, and fourth inclination angles is 45 degrees or less, and in 45 degrees, the second and fourth inclination angles are made larger than the first and third inclination angles, respectively. Accordingly, the direction of rotation of the cam 206 of the three-way stopcock diversion actuator device 200 is determined to be a predetermined direction, that is, the right rotation.

Further, in 45 degrees or less, the second and fourth inclination angles are made smaller than the first and third inclination angles, respectively, whereby the direction of rotation is determined to be a direction opposite to the predetermined direction, that is, the left direction, for example.

Further, while, in FIGS. 6 and 7, the first groove 229 and the third groove 231 are parallel to the central axis 211, these grooves may not be parallel as long as the inclination angles are sufficiently smaller than the inclination angles of the second groove 230 and the fourth groove 232. In that case, the inclination angles of the first groove 229 and the third groove 231 may be favorably opposite to the inclination angles of the second groove 230 and the fourth groove 232. Even if the inclination angles of the first groove 229 and the third groove 231 are the same as the inclination angles of the second groove 230 and the fourth groove 232, if the inclination angles of the first groove 229 and the third groove 231 are sufficiently smaller than the inclination angles of the second groove 230 and the fourth groove 232, the rotation can be performed without any problem. However, during reciprocation of the pin 214, the cam 206 is rotated in a reverse direction with respect to a proper direction of rotation in the middle of the rotation, and thus becomes less efficient.

Note that a reason of why the inclination angles of the first groove 229 and the third groove 231 are favorably sufficiently smaller than the inclination angles of the second groove 230 and the fourth groove 232 is as follows.

Hereinafter, description will be given using the second groove 230 and the third groove 231 side. However, the same applies to the first groove 229 and the fourth groove 232 side. That is, after the pin 214 that performs reciprocating movement only in the axial direction of the central axis 211 is pushed by the pneumatic cylinder 219, and is moved from the position A illustrated in FIG. 7 to the position C through the position B, the direction of the movement of the pneumatic cylinder 219 is reversed. Then, when the pin 214 is pulled by the pneumatic cylinder 219, whether the pin 214 proceeds to the direction of the position B or the direction of the position D that is the next through-position is determined by which wall surface 228 of the groove 212 the pin 214 pulled by the pneumatic cylinder 219 hits on. In this case, the angle of the third groove 231 to the central axis 211 is smaller than that of the second groove 230, and thus the pin 214 pulled by the pneumatic cylinder 219 proceeds to the third groove 231 side.

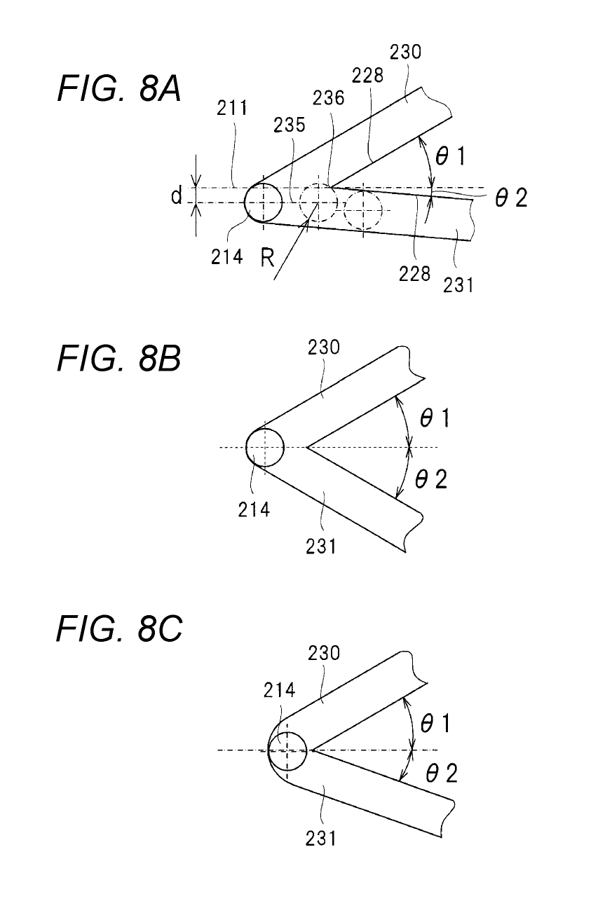

FIGS. 8A, 8B, and 8C illustrate examples of the connection portion of the second groove 230 and the third groove 231. In FIG. 8A, θ1 is larger between θ1 made by the second groove 230 and the central axis 211, and θ2 made by the third groove 231 and the central axis 211. Then, an angle 236 made by connection of the inner-side wall surfaces 228 of the connection portion of the second groove 230 and the third groove 231 is positioned above a central axis 235 parallel to the central axis 211, of the central axes of the pin 214, in FIG. 8A. Therefore, when the pin 214 is pulled by the pneumatic cylinder 219 in the right direction of FIG. 8A, the pin 214 proceeds to the third groove 231 side. When θ2 is larger than θ1, the pin 214 proceeds to the second groove 230 side, and the three-way stopcock diversion actuator device 200 is a left-rotation actuator device when FIG. 3 is viewed from the right light. However, as illustrated in FIG. 8B, if a difference between the angles θ1 and θ2 is small, the direction into which the pin 214 proceeds is unsettled, and it becomes in an unstable state where to which direction the rotation is performed is unknown.

Further, as illustrated in FIG. 8C, if a large round is given when the wall surface 228 at the outside of the connection portion of the grooves 212 is formed, friction between the pin 214 and the wall surface 228, looseness of the parts that configures the actuator device, and the like become large. Therefore, there is a possibility that the pin 214 does not proceed from the round to the far left side of the drawing. Even in that case, the direction into which the pin 214 proceeds is unsettled, and it becomes in an unstable state where to which direction the rotation is performed is unknown.

To cause the pin 214 to stably proceed to a desired direction, it is necessary to cause a distance (the distance d illustrated in FIG. 8A) between the central axis 235 parallel to the central axis 211, of the central axes of pin 214, and the central axis 211 that passes through the angle 236 made by the connection of the inner-side wall surfaces 228 of the connection portion of the second groove 230 and the third groove 231 to be sufficiently large, as illustrated in FIG. 8A. That is, it is necessary to give the angles θ1 and θ2 a substantial difference. To be specific, the distance d is desirably ½ of the radius R of the pin 214 of FIG. 8A. To enable a more smooth operation, the distance d is desirably ⅔ of the radius R of the pin 214.

Next, the cam 206 of the second example of the first embodiment and the groove 212 formed in the cam 206 will be described. The principle of the rotation of the cam 206 by the translatory motion of the pin 214, and the like are the same as the first example of using the cam 206, and thus description is omitted.

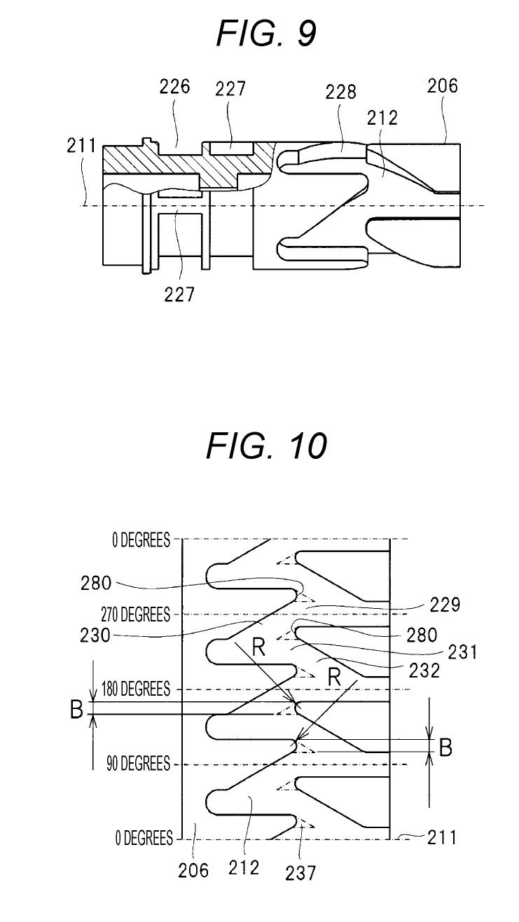

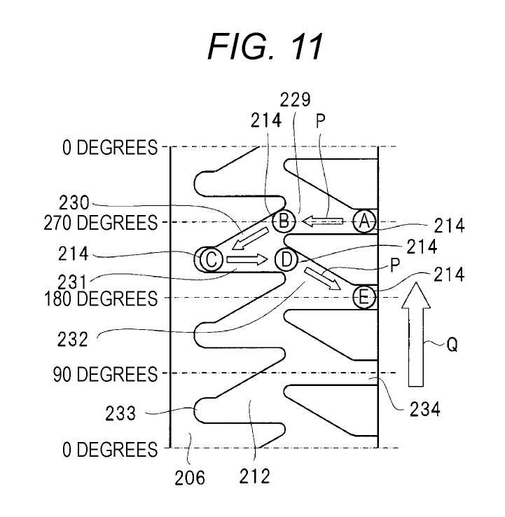

FIG. 9 illustrates the cam 206 of the second example (modification), where only the cam 206 is taken out from FIG. 3. FIG. 10 illustrates the groove 212 of the cam 206 by developing the outer periphery of the cam 206. FIG. 11 illustrates a positional relationship between the groove 212 and the pin 214.

As illustrated in FIG. 9, the groove 212 is formed in the entire right-side outer periphery of the cam 206. In the groove 212, a groove line made of the first groove 229 illustrated in the position of 270 degrees in FIG. 10 as a starting point, the second groove 230, the third groove 231, and the fourth groove 232 is formed in four places with a 90-degree pitch, and the four groove lines go around the outer periphery of the cam 206 once and are connected, which is also similar to the first example. Further, FIG. 10 is a developed diagram, and thus the wall surface 228 of FIG. 9 is illustrated by a line and all of portions (the walls of the groove) illustrated by the solid lines in FIG. 10 can be said to be the wall surfaces 228, which is also similar to the first example. A difference of the groove 212 of the second example from the groove 212 of the first example is that the wall surfaces 228 forming inner-side corners, of corners of the groove 212 made by the connection from the first groove 229 to the fourth groove 232, and a corner of the groove 212 made by the connection of the fourth groove 232 and the first groove 229, are eliminated, and round wall surfaces 280 are newly formed.

That is, the inner-side wall surfaces 228 that form the corners are eliminated, and the new round wall surfaces 280 are formed, the inner-side wall surfaces 228 being of the both-side wall surfaces 228 of the groove 212, and the corners being the corner of the grooves made by the connection of the second groove 230 and the third groove 231, and the corner of the grooves made by the connection of the fourth groove 232 and the first groove 229. The eliminated wall surfaces 228 are illustrated by the eight eliminated portions 237 having bird-beak shapes (sharp corner portions) with the narrow dashed lines in FIG. 10.

The eliminated portions 237 are the portions having a length B illustrated in FIG. 10, and having a width between the lower-side wall surface of the first groove 229 in the drawing and the upper-side surface of the third groove 231 in the drawing, and a width between the lower-side wall surface of the third groove 231 in the drawing and the upper-side surface of the first groove 229 in the drawing. Therefore, the magnitude of the round (R) of the round wall surfaces 280 is such that the radius R illustrated in FIG. 10 is ½ or less of the length B so that the round wall surfaces 280 do not stick out to the second groove 230 and the fourth groove 232.

FIG. 11 illustrates the positional relationship between the groove 212 and the pin 214. In the second example, the relationship is the same as the relationship between the groove 212 formed in the cam 206 of the first example and the pin 214 in the first embodiment of FIG. 7, and thus description is omitted. In both examples of FIGS. 7 and 11, when the pneumatic cylinder 219 is at the pushing side, the pin 214 is at the position C, and when the pneumatic cylinder 219 is at the pulling side, the pin 214 is at the position A (E). That is, the pin 214 is fit in the relief portion 233, or the cutout regio 234, and thus the output shaft 205 is not rotated even if force in the direction of rotation is applied to the output shaft 205 from an outside.

According to the direction of motion conversion mechanism and the three-way stopcock diversion actuator device 200 according to the first embodiment, the respective angles of the grooves 212 that configure the groove lines are made different with respect to the central axis 211 of the direction of rotation when the cylindrical surface of the cam 206 is developed, whereby the direction of rotation of the right rotation/left rotation can be accurately selected. Further, the four sets of the groove lines are provided in the direction of rotation of the cylindrical surface of the cam 206, whereby ¼ rotation (90 degrees) can be realized by the one-round translatory movement of the pneumatic cylinder.

Further, in the three-way stopcock diversion actuator device 200, the cam 206 has a structure of performing rotation only, and the pins 214 have a structure of performing reciprocating motion. Therefore, the parts can be easily decomposed in the axial direction of the central axis 211. Therefore, the three-way stopcock diversion actuator device 200 can be easily assembled.

Further, the grooves 212 formed in the cylindrical surface of the cam 206 have a structure established with respect to the radial direction of the cylinder of the cam 206 with approximately the same depth, and thus the cam 206 can be easily processed.

That is, in the three-way stopcock diversion actuator device 200 that diverts passages of an agent that emits high-intensity radiation, such as a device of manufacturing a PET reagent, an actuator device that can be easily processed and assembled, and enables selection of the direction of rotation of the cam 206 can be realized. Further, an actuator device that reliably enables rotation/stop at even 90 degrees can be realized.

### Second Embodiment

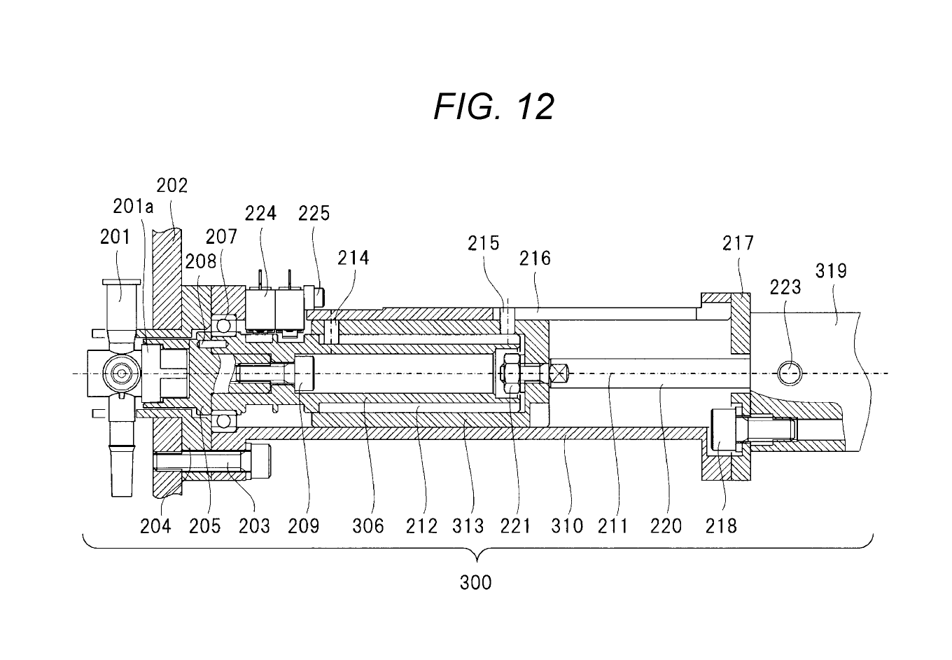

Next, a three-way stopcock diversion actuator device 300 using a direction of motion conversion mechanism that converts translatory motion into rotary motion according to the present invention will be described with reference to FIGS. 12 to 16.

Note that, while the three-way stopcock diversion actuator device described in the first embodiment is an actuator device for right rotation or for left rotation, the three-way stopcock diversion actuator device to be described in the second embodiment is an actuator device that can freely perform the right rotation and the left rotation.

Then, to realize the rotation into the both directions, parts having different structures from the structures of the first embodiment are a cam 306 against the cam 206, a housing 310 against the housing 210, a slider 313 against the slider 213, a pneumatic cylinder (pin drive unit) 319 against the pneumatic cylinder 219. A total of four members have different structures, and other members are exactly the same.

Therefore, in the second embodiment, description of the same portions as the first embodiment is omitted, and differences of the four members will be described, so that the actuator device capable of feely performing both of the right rotation and the left rotation will be described.

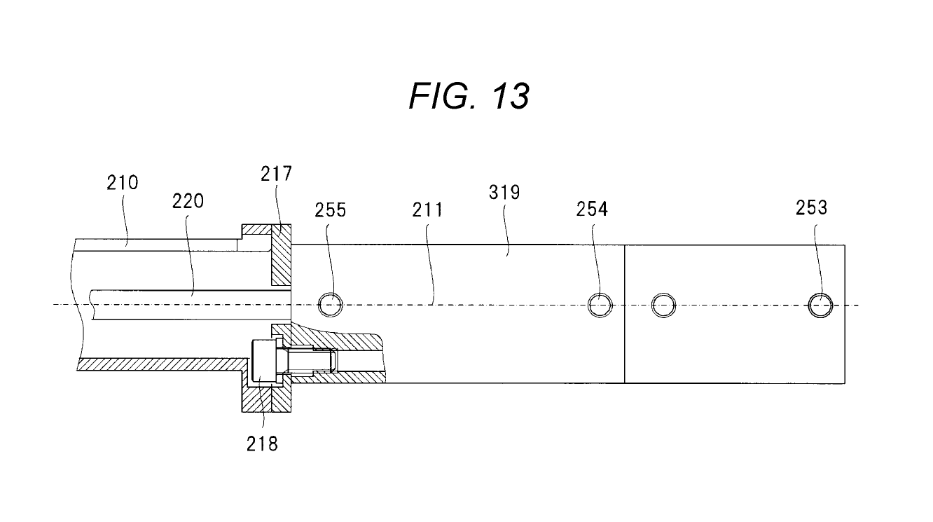

FIGS. 12 and 13 are side view and a partial cross sectional view illustrating a configuration of the three-way stopcock diversion actuator device, the cross section being obtained such that an upper half is cut in a vertical direction, and a lower half is cut in an oblique direction of about 45 degrees, based on an axis of rotation of an actuator device, similarly to the first embodiment.

The cross section of FIG. 12, which is cut in the direction perpendicular to a central axis 211, is a diagram as viewed from a right direction of FIG. 12, which is also the same as that of the first embodiment. The diagram cut at a position of limit (rotation position detection) switches 224 is the same as FIG. 4A, which is the diagram cut at the same position in FIG. 3, the diagram cut at positions of pins 214 is the same as FIG. 4B, which is the diagram cut at the same positions in FIG. 3, and the diagram cut at positions of anti-rotation pins 215 is also the same as FIG. 4C, which is the diagram cut at the same positions in FIG. 3.

A portion of the three-way stopcock diversion actuator device 300 according to the second embodiment is extended for the purpose of comparison with the actuator device of the first embodiment with the same scale, and the extended portion is divided into FIGS. 12 and 13 and illustrated.

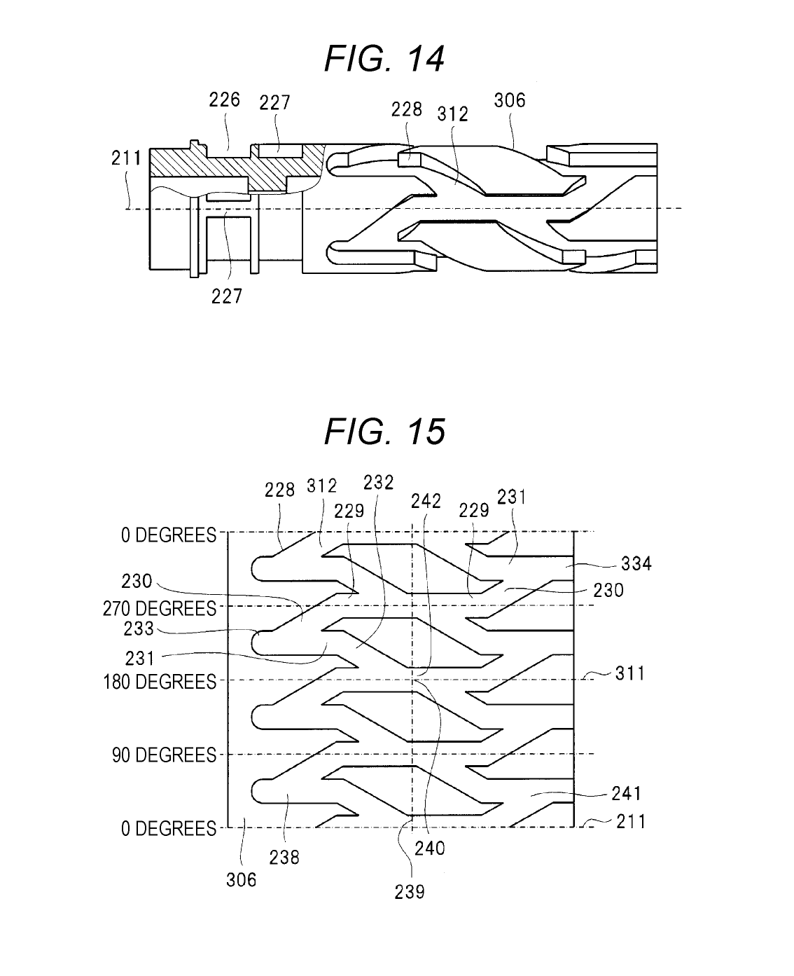

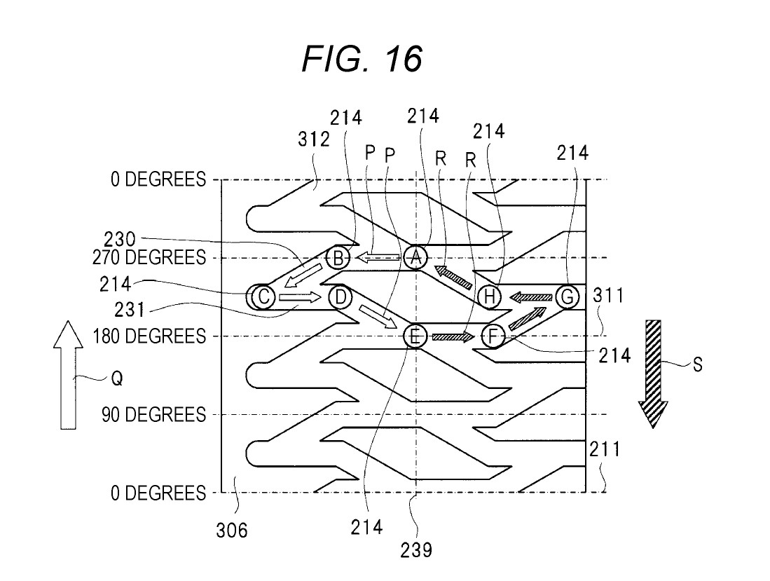

The cam 306 of the first example and the groove 312 of FIG. 14 formed in the cam 306 in the second embodiment, and a principle of rotation of the cam 306 by translatory motion of the pin 214 will be described. The side view of FIG. 14 illustrates the cam 306 of the first example, where only the cam 306 is taken out from FIG. 12. FIG. 15 illustrates the groove 312 of the cam 306 illustrated in FIG. 14 by developing an outer periphery of the cam 306. FIG. 16 illustrates a positional relationship between the groove 312 and the pin 214.

As illustrated in FIG. 14, the groove 312 is formed in the entire outer periphery of at ⅔ from the right side of the cam 306 in the longitudinal direction.

While, in FIG. 14, a wall surface 228 of the groove 312 can be seen, FIG. 15 is a developed diagram and thus the wall surface 228 is illustrated by a line. Therefore, all of portions (the walls of the groove) illustrated by the solid lines in FIG. 15 can be said to be the wall surfaces 228. FIG. 15 illustrates the central axis 211 illustrated in FIG. 14 by every 90 degrees.

In FIG. 15, in the groove 312, a groove line made of a first groove 229 illustrated in the position of 270 degrees in the drawing as a starting point, a second groove 230, a third groove 231, and a fourth groove 232 is formed in four places in a peripheral direction with a 90-degree pitch, and the four groove lines go around the outer periphery of the cam 306 once and are connected. Further, the third groove 231 slightly extends from a connection portion of the third groove 321 and the second groove 230 to a left side of the central axis 211 in an axial direction to form a relief portion 233 of the pins 214, and the first groove 229 extends from a connection portion of the first groove 229 and the fourth groove 232 to a right side of the central axis 211 in the axial direction.

Up to here, the groove 312 is approximately the same as the groove 212 of the first embodiment. However, in the second embodiment, the groove lines formed in four places in a peripheral direction with a 90-degree pitch and going around the outer periphery of the cam 306 and connected is called a first groove line 238. Then, the first groove line 238 is duplicated in a point-symmetrical manner based on an intersection 240 of a division line 239 illustrated in FIG. 15 and a central axis 311, of the central axes 211, the central axis 311 being positioned at the 180 degrees that is an angle of the direction of rotation, and the duplicated line is arranged as a second groove line 241. Further, the respective first grooves 229 of the first groove line 238 and the second groove line 241 are connected by a fifth groove 242. Further, the third groove 231 of the second groove line 241 extends from the connection portion of the third groove 231 and the second groove 230 of the second groove line 241 to the right side of the central axis 211 in the axial direction to form a cutout regio 334 that reaches the right end portion of the cam 306.

In other words, in the groove shape of FIG. 15, first, the first groove line 238 made of the first groove 229, the second groove 230, the third groove 231, and the fourth groove 232, and the second groove line 241 having a similar shape to the first groove line 238 are arranged at point-symmetric positions based on an arbitrary point in a plan view. Then, the first groove line 238 and the second groove line 241 are arranged at moved positions by the rotation with respect to the first groove line 238 based on the central axis 211 before the development, and the movement in the axial direction based on the central axis 211. Further, the respective connection positions of the first groove line 238 and the second groove line 241 are connected by the fifth groove 242 in the axial direction of the central axis 211.

Further, inclination angles with respect to the central axis 211, of one of the first groove 229 and the third groove 231, and the second groove 230 and the fourth groove 232, of the first groove line 238 and the second groove line 241, are 0 degrees (here, the inclination angles of the first groove 229 and the third groove 231 are 0 degrees). Then, one of the second groove 230 and the third groove 231 extends in the axial direction of the central axis 211 beyond the connection position of the second groove 230 and the third groove 231. Further, inclination angles with respect to the central axis 211, of one of the first groove 229 and the third groove 231, and the second groove 230 and the fourth groove 232, of the second groove line 241 are 0 degrees (here, the inclination angles of the first groove 229 and the third groove 231 are 0 degrees). Then, one of the first groove 229 and the third groove 231, and the second groove 230 and the fourth groove 232 extends in the axial direction of the central axis 211 beyond the connection position of the second groove 230 and the third groove 231, and any groove of the first groove line 238 and the second groove line 241 extends to reach the end portion of the cylinder (cam 306).

Next, a principle of rotation of the cam 306 in the second embodiment by translatory motion of the pin 214 will be described with reference to FIG. 16. Similarly to the first embodiment, in the second embodiment, actually, the cam 306 performs only rotation, and the pin 214 perform translatory reciprocating motion in the axial direction of the central axis 211. In FIG. 16, the cam 306 is fixed, and the translatory reciprocating motion in the axial direction of the central axis 211 of the pin 214, and movement in the up and down direction on the sheet corresponding to the direction of rotation of the cam 306 are combined, and movement on a two-dimensional plane is described. Further, in FIG. 16, movement of only one of the pins 214 is illustrated and the other is omitted because the drawing becomes complicated. However, the two pins 214 are used in the second embodiment, and the other pin 214 exists at a 180-degree opposite side to the position illustrated in FIG. 16 in the direction of rotation.

In FIG. 16, first, the pin 214 performs reciprocating movement by the pneumatic cylinder 319 of FIG. 12 from a position illustrated by A, which is a reference position and is also a first start position (start reference position) of this description, toward the left side in the axial direction of the central axis 211. Then, the pin 214 proceeds in the first groove 229, the second groove 230, the third groove 231, and the fourth groove 232 of FIG. 15 in the direction illustrated by the void small arrows P through positions illustrated by B, C, and D, and reaches a position E. When the pin 214 is moved from the position A to the position E, that is, from the position of 270 degrees to the position of 180 degrees illustrated in FIG. 16, the cam 306 is relatively rotated by 90 degrees that is a difference from the position of 270 degrees to the position of 180 degrees, in the direction of the void large arrow Q illustrated in the left side of FIG. 16. This direction of rotation is the right rotation when FIG. 16 is viewed from the right side. That is, the three-way stopcock diversion actuator device 300 according to the second embodiment performs the right rotation.

In other words, the pin 214 that is the translatory mechanism unit performs one-round translatory motion starting from the fifth groove 242 of FIG. 15 as the start reference position in one direction that is a direction of the first groove line 238 in the axial direction based on the central axis 211 to reach the connection position of the second groove 230 and the third groove 231 of the first groove line 238, whereby the cam 306 performs rotary motion of ¼ times. Further, the pin 214 performs one-round translatory motion from the start reference position in the other direction that is a direction of the second groove line 241 in the axial direction based on the central axis 211 to reach the connection position of the first inclined portion and the fourth inclined portion of the second groove line 241. Accordingly, the cam 306 performs rotary motion of ¼ times in a direction opposite to the case of the one-round translatory motion in the one direction.

Next, in FIG. 16, the pin 214 performs a reciprocating movement by the pneumatic cylinder 319 of FIG. 12 from the position E that is the reference position and is also a second start position (start reference position) of the present description, to the right side of the axial direction of the central axis 211. Accordingly, the pin 214 proceeds in the first groove 229, the second groove 230, the third groove 231, and the fourth groove 232, in the direction illustrated by the small arrow R with hatching through the positions F, G, and H, and reaches the position A. Then, when the pin 214 is moved from the position E to the position A, that is, from the position of 180 degrees to the position of 270 degrees illustrated in FIG. 16, the cam 306 is relatively rotated by 90 degrees that is a difference from the position of 180 degrees to the position of 270 degrees, in the direction illustrated by the large arrow S with hatching on the right side of FIG. 16. This direction of rotation is the left rotation when FIG. 16 is viewed from the right side, that is, the three-way stopcock diversion actuator device 300 according to the second embodiment performs the left rotation.

Even in the second embodiment, similarly to the first embodiment, direction of inclination with respect to the central axis 211 between the second groove 230 and the fourth groove 232 are opposite, and the inclination angles are about 30 degrees, and inclinations of the first groove 229 and the third groove 231 are parallel to the central axis 211. When the inclinations with respect to the central axis 211, of the first groove 229 and the third groove 231 are made opposite and the inclination angles are about 30 degrees, and the second groove 230 and the fourth groove 232 are made parallel to the central axis 211, and the pneumatic cylinder 319 is caused to perform reciprocating movement to the left, the actuator device performs the left rotation. Meanwhile, when the pneumatic cylinder 319 is caused to perform reciprocating movement to the right side, the actuator device performs the right rotation. However, the three-way stopcock diversion actuator device 300 of the second embodiment can perform rotation into both directions. Therefore, either is fine.

Note that, similarly to the first embodiment, each of the first, second, third, and fourth inclination angles in the first groove line 238 or in the second groove line 241 is 45 degrees or less, for example, and in 45 degrees or less, the second inclination angle and the fourth inclination angle are made larger than the first inclination angle and the third inclination angle, respectively. Accordingly, the direction of rotation of the cam 306 of the three-way stopcock diversion actuator device 300 is determined to be a predetermined direction, for example, the right rotation.

Further, in the 45 degrees or less, the second inclination angle and the fourth inclination angle are made smaller than the first inclination angle and the third inclination angle, respectively, so that the direction of rotation is determined to a direction opposite to the predetermined direction, for example, the left rotation.

Here, in the second embodiment, the rest of the parts having different structure from the first embodiment are the housing 310 against the housing 210, the slider 313 against the slider 213, and the pneumatic cylinder 319 against the pneumatic cylinder 219. The housing 310 and the slider 313 become longer because the movement range of the pin 214 becomes large. As for the pneumatic cylinder 319, while the pneumatic cylinder 219 of the first embodiment is a typical pneumatic cylinder that performs reciprocating movement, the pneumatic cylinder 319 has a structure in which two pneumatic cylinder having different strokes are connected in series. The structure and a method of use will be described below.

Next, the cam 306 of the second example in the second embodiment, and first groove line 238 and the second groove line 241 that are the groove 312 processed in the cam 306 will be described. A principle of rotation of the cam 306 freely in the both directions of rotation by the translatory motion of the pin 214, and the like are the same as the case of using the cam 306 of the first example in the second embodiment, and thus description is omitted.

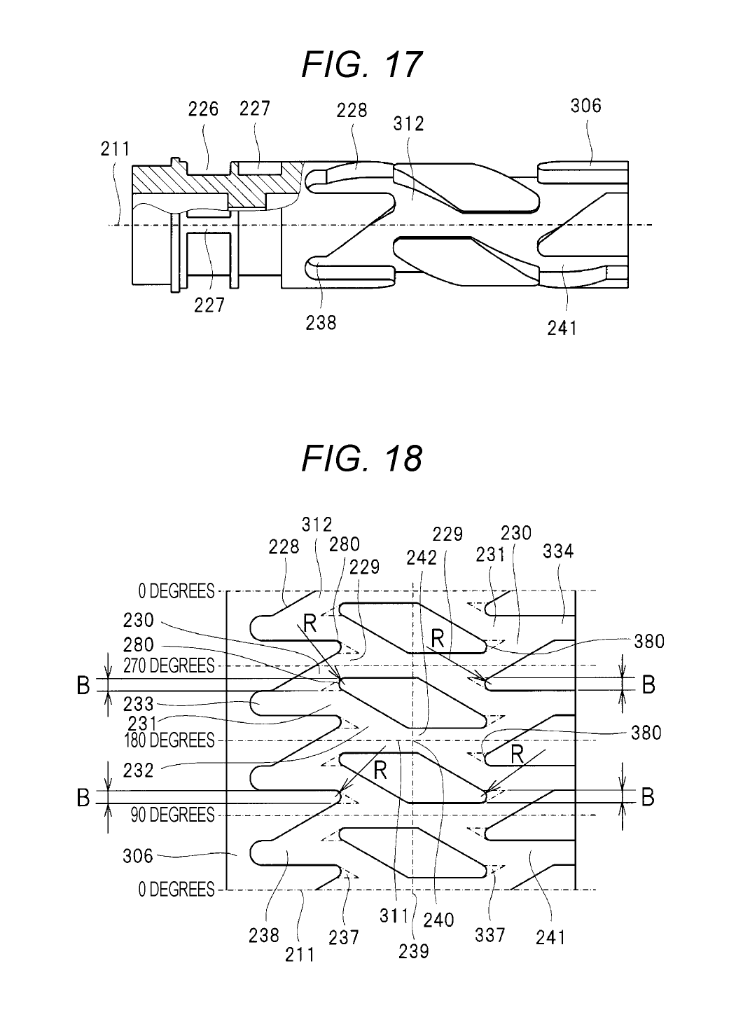

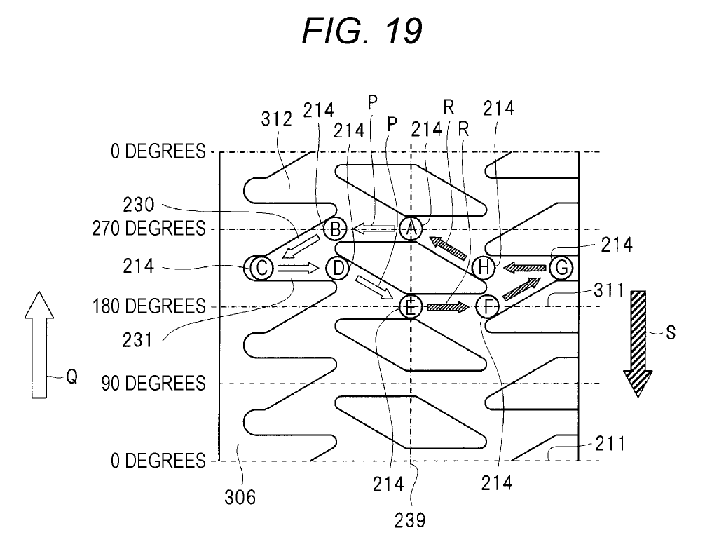

FIG. 17 illustrates the cam 306 of the second example (modification) of the second embodiment, where only the cam 306 is taken out from FIG. 12. FIG. 18 illustrates a developed outer periphery of the cam 306, such as the first groove line 238 and the second groove line 241 illustrated in FIG. 17. FIG. 19 illustrates a positional relationship between the groove 312 and the pin 214.

As illustrated in FIG. 17, the first groove line 238 and the second groove line 241, which are the groove 312, are formed in the entire outer periphery of at ⅔ from the right side of the cam 306 in the longitudinal direction. The first groove line 238 and the second groove line 241 are formed such that a groove line made of the first groove 229 illustrated in the position of 270 degrees of FIG. 18 as a starting point, the second groove 230, the third groove 231, and the fourth groove 232 is formed in four places in a peripheral direction with a 90-degree pitch, and the four groove lines go around the outer periphery of the cam 306 once and are connected. Further, the first groove line 238 is duplicated in a point-symmetrical manner based on the intersection 240, and the duplicated groove line is arranged as the second groove line 241. The respective first grooves 229 of the first groove line 238 and the second groove line 241 are connected by the fifth groove 242. The above process is the same as the second example of the second embodiment. Further, the third groove 231 of the second groove line 241 extends from the connection portion of the third groove 231 and the second groove 230 of the second groove line 241 to the right side of the axial direction of the central axis 211 to form the cutout regio 334 that reaches the right end portion of the cam 306, which is also the same as the second example of the second embodiment.

Differences of the first groove line 238 and the second groove line 241 of the second example of the second embodiment from the first groove line 238 and the second groove line 241 of the first example are corners of the groove 212 made by the connection from the respective first grooves 229 to the fourth grooves 232, of the first groove line 238 and the second groove line 241, further, corners of the groove made by the connection of the second grooves 230 and the third grooves 231, and corners of the groove made by the connection of the fourth grooves 232 and the first grooves 229, of corners of the groove 212 made by the connection of the fourth grooves 232 and the first grooves 229. With respect to the corners, the inner-side wall surfaces 228 that form the corners, of the wall surfaces 228 existing at both sides of the groove 212, are eliminated, and round wall surfaces 280 and round wall surfaces 380 are newly formed. The above eliminated wall surfaces 228 are illustrated by eight eliminated portions 237 and 337 having bird-beak shapes (sharp corner portions) with the narrow dashed lines in FIG. 18.

In other words, the groove shape illustrated in FIG. 18 is formed such that, in each of the first groove line 238 and the second groove line 241, the corner of the grooves made by the connection from the first groove 229 to the fourth groove 232 are formed by an arc having a radius R that is ½ or more of the distance B between the first groove 229 and the third groove 231. Further, each of the inner-side corner of the groove made by the connection of the second groove 230 and the third groove 231, and the inner-side corner of the groove made by the connection of the fourth groove 232 and the first groove 229, of the corners of the groove made by the connection of the fourth groove 232 and the first groove 229, is formed by an arc having a radius R that is ½ or more of the distance B between the first groove 229 and the third groove 231

Note that details of the eliminated portions 237 and 337 are the same as the example of the description of the groove 212 of the second example of the first embodiment, and thus description is omitted here.

FIG. 19 illustrates a positional relationship between the first groove line 238 and the second groove line 241 of FIG. 18, and the pin 214. The second example of the second embodiment is also the same as the relationship between the first groove line 238 and the second groove line 241 formed in the cam 306 of the first example and the pin 214 in the second embodiment of FIG. 16, and thus description is omitted. However, in both of the examples of FIGS. 16 and 19, the pin 214 is at the position C when the pneumatic cylinder 319 is at the pushing side, the pin 214 is at the position A (E) when the pneumatic cylinder 319 performs intermediate stop, and the pin 214 is at the position G when the pneumatic cylinder 319 is at the pulling side. Therefore, the pin 214 is fit in the relief portion 233, the cutout regio 234, or the fifth groove 242, and thus the output shaft 205 is not rotated even if force in the direction of rotation is applied to the output shaft 205 from an outside.

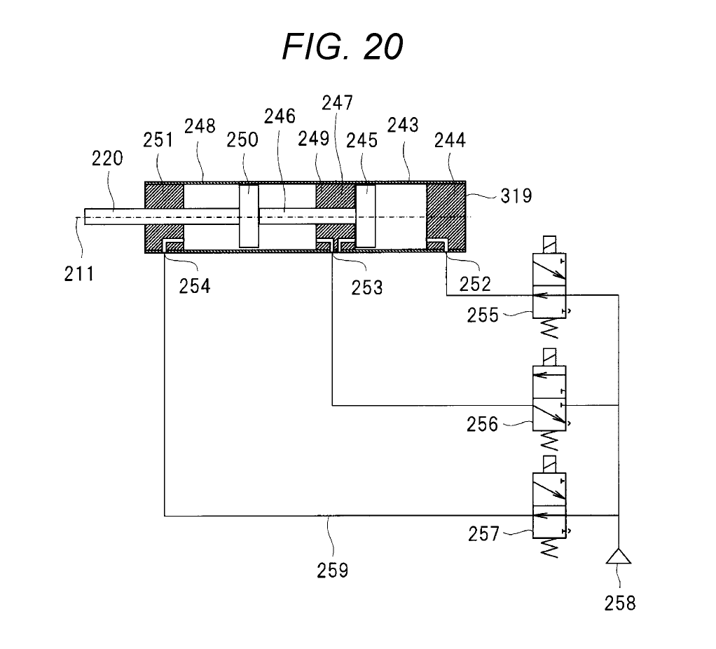

Next, the pneumatic cylinder 319 used in the second embodiment will be described. FIG. 20 schematically illustrates a structure of the pneumatic cylinder 319 illustrated in FIG. 13 used in the second embodiment, to which piping, control solenoid valves, and an air pressure source are added.

While the pneumatic cylinder 219 is a typical pneumatic cylinder that simply reciprocates, the pneumatic cylinder 319 has a structure in which two pneumatic cylinders having different strokes are connected in series, and is typically called multi-position pneumatic cylinder. That is, the pneumatic cylinder 319 is mainly configured from a first cylinder 243, a first head cover 244, a first piston 245, a first piston rod 246, a first rod cover 247, a second cylinder 248, a second head cover 249, a second piston 250, a piston rod 220, and a second rod cover 251. The pneumatic cylinder 319 is arranged on approximately the same axis as the central axis 211.

Further, the pneumatic cylinder 319 has three ports (intake and exhaust ports), which are a port (intake and exhaust port) 252, and a port (intake and exhaust port) 253, and a port (intake and exhaust port) 254, respectively. Each of the ports (intake and exhaust ports) of the pneumatic cylinder 319 is connected with a solenoid valve 255, a solenoid valve 256, a solenoid valve 257, and an air pressure source 258 with piping 259 as illustrated in FIG. 20. Although description is omitted, a screw is formed at a tip of the piston rod 220 on the left side of the drawing, as illustrated in FIG. 12. Further, the first piston 245 and the first piston rod 246 are integrally moved, the second piston 250 and the piston rod 220 are integrally moved, and the first rod cover 247 and the second head cover 249 are common.

In FIG. 20, the solenoid valve 255, the solenoid valve 256, and the solenoid valve 257 are in an OFF state where no electricity is supplied. In this state, the air pressure supplied from the air pressure source 258 is supplied to the port (intake and exhaust port) 252 and the port (intake and exhaust port) 254 through the solenoid valve 255 and the solenoid valve 257, and the first piston rod 246 is in a state of being pushed, pulls the second piston 250, and stops in a way point.

Next, when the solenoid valve 256 is turned OFF after the solenoid valve 256 is turned ON and the piston rod 220 is fully pushed out, the piston rod 220 performs a reciprocation motion between the state of being fully pushed out and the way point, and then returns to the way point illustrated in FIG. 20. Next, after the solenoid valve 255 is turned ON and the piston rod 220 is fully pulled, the solenoid valve 257 is turned ON, the solenoid valve 255 is turned OFF, and finally the solenoid valve 257 is turned OFF. When the solenoid valve 257 is turned OFF, the piston rod 220 performs reciprocating motion between the state of being fully pulled and the way point, and then returns to the way point illustrated in FIG. 20. Since the piston rod 220 finally moves the pin 214 in the axial direction of the central axis 211, the three-way stopcock diversion actuator device 300 is rotated to the right by 90 degrees with the operation of the solenoid valve 256. Meanwhile, the three-way stopcock diversion actuator device 300 can be rotated to the left by 90 degrees with the operation of the solenoid valve 255 and the solenoid valve 257.

According to the three-way stopcock diversion actuator device 300 of the second embodiment, when the cylindrical surface of the cam 306 is developed, four sets of the groove lines with respect to the central axis 211 of rotation is provided with respect to the direction of rotation of the cylindrical surface of the cam 306, and the second groove line 241 in which the four sets of the groove lines are arranged to face on the central axis 211 is arranged and connected with the first groove line 238, and the pins 214 is allowed to go back and forth between the first groove line 238 and the second groove line 241, whereby the normal rotation and the reverse rotation of the cam 306 can be made selectable.

That is, both of the normal rotation and the reverse rotation of the rotation of the cock 201a in the three-way stopcock 201 can be performed.

Note that other effects obtained by the three-way stopcock diversion actuator device 300 of the second embodiment are the same as the effects obtained by the three-way stopcock diversion actuator device 200 of the first embodiment, and thus repetitive description is omitted.

### Third Embodiment

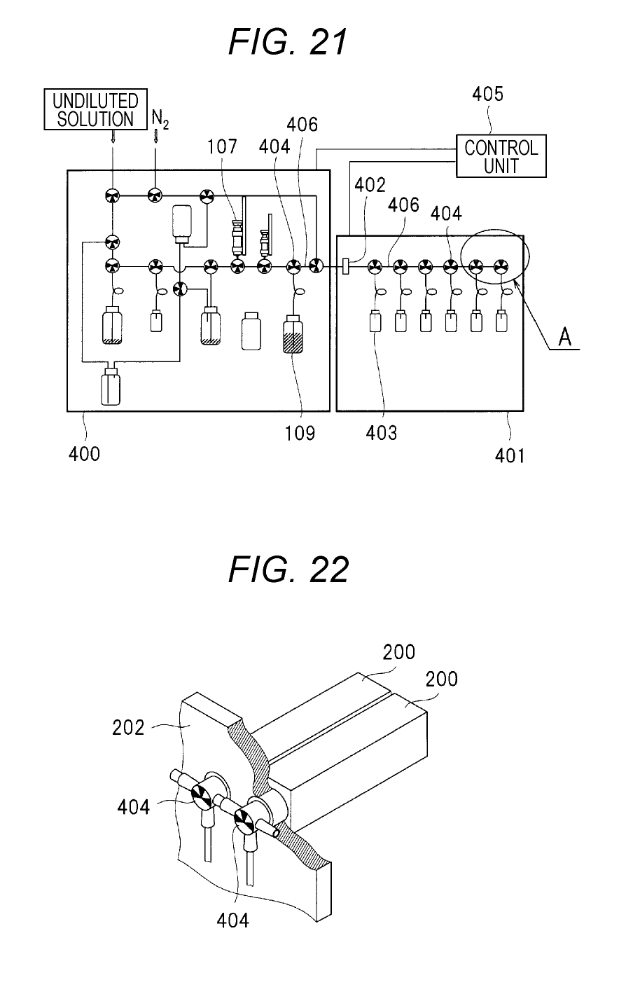

Next, an operation of a PET reagent manufacturing system (reagent manufacturing apparatus) using the three-way stopcock diversion actuator devices of the first and second embodiments will be described with reference to FIGS. 21 and 22.

FIG. 21 is a configuration diagram illustrating an example of a PET reagent manufacturing system (reagent manufacturing apparatus). The PET reagent manufacturing system (reagent manufacturing apparatus) is configured from a mixing unit 400, a dispensing unit 401, and a control unit 405 that controls these units. Although illustration is omitted, these units are accommodated in a chamber (not illustrated) that protects these units from radiation. Among the units, the function of the mixing unit 400 has been described as a piping system 100 in the first embodiment up to the stage before mixed liquor is dispensed in individual containers, and thus repetitive description is omitted. Here, description will be started from when the weight and the intensity of radiation in a synthesis container 109 have reached predetermined reference values.

A filter 402 for removing bacteria or impurities if contained, and collection containers 403 (here, six containers) for collecting a PET reagent adjusted to have a predetermined concentration after the weight and the intensity of radiation have reached the predetermined reference values are provided inside the dispensing unit 401. Further, three-way stopcocks 404 (here, six three-way stopcocks) for diverting passages into the collection containers 403 at the time of collecting the PET reagent are furnished as described in the drawing.

To dispense the adjusted PET reagent in the synthesis container 109 into the respective collection containers 403, the adjusted PET reagent of a predetermined amount in the synthesis container 109 is sucked by a syringe pump 107, and the sucked PET reagent is dispensed to the collection container 403. At that time, the passage is determined by diverting of the three-way stopcocks 404 in the middle of piping 406 that connects the syringe pump 107 and the collection containers 403, in accordance with the suction and discharging. The device that diverts the three-way stopcocks 404 is a three-way stopcock diversion actuator device 200 (or 300) described in the first embodiment.

FIG. 22 is an enlarged partial perspective view illustrating an enlarged A portion of FIG. 21, where a part of an installation panel 202 is broken. The three-way stopcock diversion actuator device 200 is installed at a back surface of the installation panel 202 and at a position corresponding to each three-way stopcock 404, the piping 406 that connects the three-way stopcock actuator devices and the three-way stopcocks 404 and the containers are attached from a front surface of the installation panel 202. Such an installation form is employed in both of the mixing unit 400 and the dispensing unit 401, and the actuator devices and the syringe pump 107 are controlled by the control unit 405. That is, the control unit 405 causes the pins 214 to perform translatory motion along an extending direction of the cam 206, and rotates the cam 206 with respect to the central axis 211 of rotation, thereby to control diversion of the passages of the three-way stopcocks 404. Further, the control unit 405 controls timing to divert the passages of the three-way stopcocks 404.

As described in the first embodiment, the three-way stopcock diversion actuator device 200 is arranged according to an optimum rotation system that is different due to restriction of the direction of rotation of each three-way stopcock 404, and the like. That is, the three-way stopcock diversion actuator device is selected from the right-rotation three-way stopcock diversion actuator device 200 of the first embodiment, the left-rotation three-way stopcock diversion actuator device 200 of the first embodiment, and the three-way stopcock diversion actuator device 300 of the second embodiment capable of being rotated in the both directions. Of course, all actuator devices can be the three-way stopcock diversion actuator device 300 of the second embodiment capable of being rotated in the both directions.

According to the reagent manufacturing apparatus (reagent manufacturing system) of the third embodiment, by use of the three-way stopcock diversion actuator device 200 or 300 of the first or second embodiment, even if a reagent that emits high-intensity radiation is used, the cock can be automatically rotated/stopped at every 90 degrees by the actuator device using air pressure.

Accordingly, even if a reagent having high-intensity radiation is used, mixture and dispensation can be reliably performed.

While the invention made by the inventor has been specifically described based on the embodiments, the present invention is not limited to the embodiments, and various modifications can be made without departing from the gist of the invention.

Note that the present invention is not limited to the above-described embodiments, and includes various modifications. For example, the embodiments have been described for explaining the present invention in ways easy to understand, and the present invention is not limited to one including all of the described configurations.

Further, a part of the configuration of a certain embodiment can be replaced with the configuration of another embodiment, and the configuration of another embodiment can be added to the configuration of a certain embodiment. Further, addition, deletion, or replacement of another configuration can be made with respect to a part of the configuration of each embodiment. Note that the members and the relative sizes described in the drawings are simplified and idealized for describing the present invention in ways easy to understand. Thus, when implemented, the members have more complicated shapes.

Further, in the above-described embodiments, the three-way stopcocks are assumed. However, two-way stopcocks or multi-way stopcocks are applicable. Therefore, the embodiments of the present invention are applicable not only to the three-way stopcocks but also to other passage diversion valves and rotation diversion devices.

Further, in the above-described embodiments, the case where the reagent manufacturing apparatus includes both of the mixing device (mixing unit) and the dispensing device (dispensing unit) has been described. However, the reagent manufacturing apparatus may be a single manufacturing device of the mixing device or the dispensing device.

What is claimed is:

1. A direction of motion conversion mechanism adapted to convert translatory motion into rotary motion, comprising:
a translatory mechanism unit including a cam follower arranged in a groove of a cam having the groove formed in a cylindrical surface, and the cam follower adapted to relatively move along the groove, and to perform the translatory motion; and
a rotation mechanism unit in which the cam performs the rotary motion, wherein
a translatory axis of the translatory mechanism unit and a central axis of rotation of the rotation mechanism unit are parallel or on the same straight line,
in a plan view in which the cylindrical surface is developed,
the groove includes
a first groove having a first inclination angle with respect to the central axis of rotation of the rotation mechanism unit,
a second groove having a second inclination angle with respect to the central axis of rotation,
a third groove having a third inclination angle with respect to the central axis of rotation, and
a fourth groove having a fourth inclination angle with respect to the central axis of rotation,
the first, second, third, and fourth grooves have a linked shape,
directions of respective inclinations of the first groove and the third groove are opposite with respect to the central axis of rotation, and
direction of respective inclinations of the second groove and the fourth groove are opposite with respect to the central axis of rotation.

2. The direction of motion conversion mechanism according to claim 1, wherein
each of the first, second, third, and fourth inclination angles is 45 degrees or less,
a direction of rotation of the rotary motion is determined to be a predetermined direction by making of the second inclination angle and the fourth inclination angle larger than the first inclination angle and the third inclination angle, respectively, and
a direction of rotation of the rotary motion is determined to be a direction opposite to the predetermined direction by making of the second inclination angle and the fourth inclination angle smaller than the first inclination angle and the third inclination angle, respectively.

3. The direction of motion conversion mechanism according to claim 1, wherein
smaller inclination angles of the grooves with respect to the central axis of rotation, of the first groove and the third groove, and the second groove and the fourth groove, are 0 degrees, and a one end extending in an axial direction of the central axis of rotation beyond a connection position of the grooves of the smaller inclination angles, and an inclined portion of the grooves of larger inclination angles extends to reach an end portion of a cylinder.

4. The direction of motion conversion mechanism according to claim 1, wherein
four sets of grooves made of the first groove, the second groove, the third groove, and the fourth groove are provided in a circumferential direction of the cylindrical surface, and the four sets of the grooves are formed by being linked in the circumferential direction.

5. The direction of motion conversion mechanism according to claim 1, wherein
the rotation mechanism unit performs the rotary motion of ¼ times by the cam follower of the translatory mechanism unit performing one-round translatory motion, starting from a connection position of the fourth groove and the first groove as a start reference position, into one of an axial direction using the central axis of rotation as a reference, to reach a connection position of the second groove and the third groove.

6. The direction of motion conversion mechanism according to claim 1, wherein
in a plan view in which the cylindrical surface is developed,
of corners of groove made by connection of grooves from the first groove to the fourth groove and a corner of groove made by connection of the fourth groove and the first groove,
each of an inner-side corner of groove made by connection of the second groove and the third groove, and an inner-side corner of groove made by connection of the fourth groove and the first groove is formed by an arc having a radius that is ½ of a distance between the first groove and the third groove.

7. The direction of motion conversion mechanism according to claim 1, wherein
a first groove line made of the first, second, third, and fourth grooves, and a second groove line having a similar shape to the first groove line are arranged in point symmetrical positions using an arbitrary one point as a reference in a plan view, the first groove line and the second groove line are arranged in moved positions by rotation with respect to the first groove line using the central axis of rotation before development as a reference and movement in an axial direction using the central axis of rotation as a reference, and connection positions of the first groove line and the second groove line are connected by a fifth groove in an axial direction of the central axis of rotation.

8. The direction of motion conversion mechanism according to claim 7, wherein,
the inclination angles with respect to the central axis of rotation, of one of the first groove and the third groove, and the second groove and the fourth groove, of the first groove line and the second groove line, are 0 degrees, and the one of the first groove and the third groove, and the second groove and the fourth groove extends in the axial direction of the central axis of rotation beyond the connection position of the second groove and the third groove, and
the inclination angles with respect to the central axis of rotation, of one of the first groove and the third groove, and the second groove and the fourth groove, in the second groove line, are 0 degrees, and the one of the first groove and the third groove, and the second groove and the fourth groove extends in the axial direction of the central axis of rotation beyond the connection position of the second groove and the third groove, and any groove of the first groove line and the second groove line extends to reach an end portion of a cylinder.

9. The direction of motion conversion mechanism according to claim 7, wherein
the first groove line and the second groove line are made of a first inclined portion, a second inclined portion, a third inclined portion, and a fourth inclined portion, four sets of the first groove line and the second groove line are provided in a circumferential direction of the cylindrical surface, and are linked in the circumferential direction.

10. The direction of motion conversion mechanism according to claim 7, wherein
the rotation mechanism unit performs rotary motion of ¼ times, by the cam follower of the translatory mechanism unit performing one-round translatory motion using the fifth groove as a start reference position in one direction that is a direction of the first groove line in the axial direction using the central axis of rotation as a reference, to reach the connection position of the second groove and the third groove of the first groove line, and the rotation mechanism unit performs rotary motion of ¼ times in a direction opposite to the case of the one-round translatory motion in the one direction, by the cam follower performing one-round translatory motion from the start reference position in the other direction that is a direction of the second groove line in the axial direction using the central axis of rotation as a reference, to reach a connection position of a first inclined portion and a fourth inclined portion.

11. The direction of motion conversion mechanism according to claim 7, wherein
the cam follower has a columnar shape having a central axis intersecting with the central axis of rotation of the rotary motion, and a diameter of the columnar shape is smaller than the groove.

12. The direction of motion conversion mechanism according to claim 7, wherein
in a plan view in which the cylindrical surface is developed,
of corners of groove made by connection of grooves from the first groove to the fourth groove and a corner of groove made by connection of the fourth groove and the first groove,
each of an inner-side corner of groove made by connection of the second groove and the third groove, and an inner-side corner of groove made by connection of the fourth groove and the first groove is formed by an arc having a radius that is ½ of a distance between the first groove and the third groove.

13. The direction of motion conversion mechanism according to claim 7, wherein
the groove is formed in an outer periphery of the cylindrical surface, and a depth of the groove is constant.

14. An actuator device including a direction of motion conversion mechanism adapted to convert translatory motion into rotary motion, the actuator device comprising:
a translatory mechanism unit including a pin that is a cam follower arranged in a groove of a cam having the groove in a cylindrical surface and to which a three-way stopcock is connected, the cam follower adapted to relatively move along the groove, and to perform the translatory motion;
a rotation mechanism in which the cam performs the rotary motion; and
a pin drive unit adapted to cause the pin to perform the translatory motion along an extending direction of the cam, and to rotate the cam with respect to a central axis of the rotation mechanism unit, wherein
a translatory axis of the translatory mechanism unit and a central axis of rotation of the rotation mechanism unit are parallel or on the same straight line,
in a plan view in which the cylindrical surface is developed,
the groove includes
a first groove having a first inclination angle with respect to the central axis of rotation of the rotation mechanism unit,
a second groove having a second inclination angle with respect to the central axis of rotation,
a third groove having a third inclination angle with respect to the central axis of rotation, and
a fourth groove having a fourth inclination angle with respect to the central axis of rotation,
the first, second, third, and fourth grooves have a linked shape,
directions of respective inclinations of the first groove and the third groove are opposite with respect to the central axis of rotation, and
directions of respective inclinations of the second groove and the fourth groove are opposite with respect to the central axis of rotation.

15. A reagent manufacturing apparatus including an actuator device including a direction of motion conversion mechanism adapted to convert translatory motion into rotary motion, the reagent manufacturing apparatus comprising:
the actuator device including a translatory mechanism unit including a pin that is a cam follower arranged in a groove of a cam having the groove in a cylindrical surface and to which a three-way stopcock is connected, the pin adapted to relatively move along the groove, and to perform the translatory motion;
a rotation mechanism unit in which the cam performs the rotary motion;
piping to which a plurality of the three-way stopcocks is connected; and
a control unit adapted to divert a passage of the three-way stopcock by causing the pin to perform the translatory motion along an extending direction of the cam, and to rotate the cam with respect to a central axis of the rotation mechanism unit, wherein
a translatory axis of the translatory mechanism unit and a central axis of rotation of the rotation mechanism unit are parallel or on the same straight line,
in a plan view in which the cylindrical surface is developed,
the groove includes
a first groove having a first inclination angle with respect to the central axis of rotation of the rotation mechanism unit,
a second groove having a second inclination angle with respect to the central axis of rotation,
a third groove having a third inclination angle with respect to the central axis of rotation, and
a fourth groove having a fourth inclination angle with respect to the central axis of rotation,
the first, second, third, and fourth grooves have a linked shape,
directions of respective inclinations of the first groove and the third groove are opposite with respect to the central axis of rotation,
directions of respective inclinations of the second groove and the fourth groove are opposite with respect to the central axis of rotation, and
the control unit controls timing to divert the passage of the three-way stopcock.
